(19) United States
(12) Patent Application Publication
(10) Pub. No.: US 2026/0098967 A1
(43) Pub. Date: Apr. 9, 2026

(54) METHOD OF ESTIMATING A CONSTRAINED ZONOTOPE ENCLOSING A STATE REPRESENTING MOTION OF AT LEAST ONE MOBILE TARGET GOVERNED BY A NONLINEAR MODEL

(71) Applicants: Institut Superieur de L'Aeronautique et de L'Espace, Toulouse (FR); Centre National de la Recherche Scientifique (CNRS), Paris (FR)

(72) Inventors: Jan BOLTING, Toulouse (FR); Soheib Fergani, Toulouse (FR)

(73) Assignees: Institut Superieur de L'Aeronautique et de L'Espace, Toulouse (FR); Centre National de la Recherche Scientifique (CNRS), Paris (FR)

(21) Appl. No.: 19/404,467

(22) Filed: Dec. 1, 2025

Related U.S. Application Data
(63) Continuation of application No. 17/608,717.

(30) Foreign Application Priority Data
May 7, 2019 (EP) 19305582.9

(51) Int. Cl. G01S 19/13

(52) U.S. Cl. CPC G01S 19/13

(57) ABSTRACT

A method for estimating a constrained zonotope enclosing a motion state of at least one mobile target, the method comprising: a) linearizing a nonlinear transition model at an element of a first zonotope (Zₓ(tₖ₋₁)), b) computing transition linearization errors at different elements of the first zonotope (Zₓ(tₖ₋₁)), c) computing a second zonotope that contains all linearization errors, d) propagating (102) the first zonotope so as to obtain an a priori zonotope (\hat{Z}ₓ(tₖ)) enclosing the motion state at a second moment (tₖ) after the first moment (tₖ₋₁), wherein the a priori zonotope (\hat{Z}ₓ(tₖ)) is a linear projection of a hypercube, the hypercube being subject to at least one linear constraint, e) updating (104) the a priori zonotope (\hat{Z}ₓ(tₖ)) so as to obtain an a posteriori constrained zonotope (Z′ₓ(tₖ)) enclosing the motion state at the second moment (tₖ).

### TECHNICAL FIELD

The invention relates to the technical field of set-membership state estimation techniques.

The invention deals with a method of estimating a constrained zonotope containing a state representing motion of at least one mobile target governed by a nonlinear model.

### BACKGROUND

Unmanned vehicles have seen a considerable rise in their level of autonomy over the last years, leading up to present on-going efforts to integrate unmanned aircraft systems (UAS) into the national airspaces and of autonomous cars into the general traffic. It has been known for quite some time that cooperative motion strategies can unlock a number of benefits with considerable economic potential. Automatic platooning of ground vehicles can increase highway capacity, avoid traffic jams and reduce consumption of individual vehicles. Tight formation flight has been demonstrated to enable significant aircraft range enhancements. The most prominent examples include range improvements thanks to the exploitation of wake vortex effects in tight aircraft formations and automatic in-air refueling. To execute these cooperative motion strategies in a safe and efficient manner, relative positions of vehicles need to be estimated with decimeter level, if not centimeter level accuracy.

For tight formation flight, as standalone positioning based on Global Navigation Satellite Systems (GNSS) does not provide the necessary accuracy, a variety of differential positioning techniques has been proposed in the past. Numerous sensor fusion approaches can be found in the literature of the last decades, employing inertial measurement units, differential GNSS with or without exploiting the phase information, machine vision or combinations of both. More recently, inexpensive, decimeter-precision Ultra-Wideband (UWB) ranging sensors have been successfully shown to improve the robustness of airborne Real Time Kinematics (RTK) solutions.

Common among these existing approaches is their reliance on probabilistic filtering techniques such as the Unscented (UKF) or the Extended Kalman Filter (EKF). As is well known, many practical nonlinear estimation problems violate the underlying assumption of both the UKF and the EKF, notably the key assumption of distributions of process model and observation model uncertainties being known. In reality, typically only approximations of the stochastic properties of both sources of uncertainty are available. In spite of this inherent and well-known issue, both EKF and UKF have been demonstrated to work well in practice, providing accurate mean state estimates.

However, when it comes to safe cooperative motion of multiple agents in close proximity, the consistent computation of filter state uncertainty is of even more crucial importance than accurate point estimates. Due to the approximations involved (the linearization steps performed by the EKF and the unscented transform of the UKF), guaranteeing filter consistency is an open problem for nonlinear estimation problems when employing the EKF or UKF. However, we consider algorithms that can compute guaranteed enclosures of vehicle states a key element for the further safe integration of autonomous vehicles into heterogeneous environments such as mixed air traffic and common road traffic.

Set-membership state estimation techniques offer an interesting alternative to probabilistic frameworks in this regard. Set-membership estimators rely on a set-valued process model, assuming that observation and process model uncertainties are contained in known compact sets, e.g. intervals. No assumptions about the error distribution within these sets are required. The exact set-membership estimation problem is usually computationally intractable for nonlinear systems. Research is directed at finding implementable but tight outer approximations of the involved set operations. Numerous algorithms have been proposed over the last decades, employing set shapes such as ellipsoids or intervals. The common challenge all set-membership estimators are facing consists of finding a tradeoff between conservatism—the degree of over-approximation introduced by representing complex sets by simpler, computationally tractable ones—and computational effort.

In spite of the merits of set-membership approaches, their application to relative agent localization has received little attention. A cooperative set-membership localization algorithm for ground vehicles based on the Set Inversion Via Interval Analysis algorithm (SIVIA) has been proposed. SIVIA and related nonlinear set inversion algorithms provide tight enclosures when applied to state estimation algorithms, with their degree of approximation only limited by available computing resources. However, the complexity of these algorithms increases however typically fast with the number of states, limiting their usefulness beyond 2D ground vehicle localization applications.

Ellipsoids provide good computational performance thanks to their constant complexity and have been successfully applied to relative agent localization in simulation. Recently, zonotopes have received increased attention for guaranteed state estimation. Zonotopes provide more flexibility than ellipsoids, their complexity being a design parameter. One inherent problem of zonotopes is their symmetry, which introduces additional conservatism whenever actual state sets exhibit strong asymmetries. A second problem is that the intersection of two zonotopes does not always result in a zonotope, thus, as it is the case for ellipsoids, outer approximations of intermediate sets must be computed at each filter recursion, potentially involving solving a convex optimization problem.

### SUMMARY OF THE INVENTION

The invention aims at solving or at least mitigating both of these deficiencies.

A first aspect of the invention is the method of claim 1.

The a priori zonotope used in the method of claim 1 is a constrained zonotope. This class of zonotopes allows to better approximate asymmetrical set shapes. As an additional advantage, they are closed under intersection and closed under the Minkowski sum operation.

The method according to the first aspect of the invention may comprise the following optional features.

The element at which the nonlinear transition model is linearized may be a center of a smallest interval enclosure containing the first constrained zonotope.

The method may further comprise linearizing a nonlinear observation model at an element of the first constrained zonotope or the a priori zonotope, so as to produce a linear observation model, wherein the observation model used at step e) is the linear observation model produced.

The element at which the nonlinear observation model is linearized may be a center of a smallest interval enclosure containing the a priori zonotope.

The method may further comprise:
computing observation linearization errors at different elements of the first constrained zonotope or the a priori zonotope, wherein an observation linearization error at a given element of the first constrained zonotope or the a priori zonotope is a difference between an output resulting from applying the nonlinear observation model to the given element and an output resulting from applying the linear observation model to the given element,
computing a fourth constrained zonotope that contains all the observation linearization errors computed, wherein the a posteriori constrained zonotope depends on the fourth constrained zonotope.

The observation data of the mobile target may have been acquired at a third moment different from the second moment, and the method may further comprises:
inflating the fourth constrained zonotope so as to obtain an inflated constrained zonotope forming a strip in the state space and taking into account all possible variations of the motion state between the second moment and the third moment, and possibly taking into account measurement noise induced by the sensor,
computing the a posteriori constrained zonotope as an intersection between the a priori constrained zonotope and the inflated constrained zonotope.

The method may further comprise
determining a complexity level of the a posteriori constrained zonotope,
if the complexity level is greater than a threshold, applying a reduction process to the a posteriori constrained zonotope) so as to obtain an a posteriori zonotope having a lower complexity than and containing the a posteriori zonotope before the reduction.

The method may further comprise using the a posteriori constrained zonotope as first constrained zonotope and using the second moment as first moment in a subsequent execution of steps a) to e) defined in claim 1.

The method may further comprise
computing a maximum time interval between the first moment and a moment at which the observation data has been acquired by the sensor,
if the maximum time interval is greater than a predetermined duration, applying the linear transition model to the predetermined constrained zonotope so as to produce the a priori constrained zonotope, else using the predetermined constrained zonotope as the a priori constrained zonotope.

The observation data may comprise at least one of the following data acquired by a GNSS receiver: a pseudo-range, a carrier phase acquired, a range between the mobile target and another mobile target.

The motion data may include motion data of the mobile target relative to another mobile target.

The first constrained zonotope may be computed using a Vector Set Inverter Via Interval Analysis algorithm.

A second aspect of the invention is a computer program product comprising instructions which, when the program is executed by a computer, cause the computer to carry out the method of the first aspect of the invention.

### GENERAL DESCRIPTION OF THE DRAWINGS

FIG. 1 schematically represents a device for estimating a set enclosing the motion state of a mobile target;

FIG. 2 illustrates the steps of an example method for estimating a C-zonotope enclosing a state x of a system;

FIG. 3 illustrates a sequence of operations of a propagation step of the method shown in FIG. 2;

FIG. 4 is a graphical representation of the position p and distance d to an x-axis for a target device and for a beacon;

FIG. 5 represents snapshots of the propagation, update and reduction steps of the method shown in FIG. 2;

FIG. 6 is a graphical representation of a true state trajectory of the target device;

FIG. 7 is a graphical representation of a CZESMF enclosure of the target device;

FIG. 8 is a graphical representation of a position interval enclosure of the target device;

FIG. 9 is a graphical representation of a velocity interval enclosure of the target device;

FIG. 10 is a graphical representation of the position of another target device;

FIG. 11 represents an interval enclosure of a subpaving obtained by VSIVIA;

FIG. 12 represents an obtained a priori C-zonotope along with an obtained a posteriori C-zonotope and a reduced a posteriori C-zonotope for the target device of FIG. 10;

FIG. 13 represents the a priori and a posteriori C-zonotopes in the case of an increased observation timing noise;

FIG. 14 represents a full state enclosure trajectory for the target device of FIG. 10;

FIG. 15 represents a full state enclosure trajectory for the target device of FIG. 10 in the case of an increased observation timing noise;

FIG. 16 is a graphical representation of two radii of range linearization error interval measurements obtained by two distinct approaches;

FIG. 17 represents the positions of two other target devices during a simulation;

FIG. 18 represents set volumes obtained by speed norm prediction and by T3D prediction, using a GNSS update or a GNSS+UWB update;

FIG. 19 represents relative position set volumes obtained using a CZESMF filter and using an IESMF filter.

### DETAILED DESCRIPTION OF AT LEAST ONE EMBODIMENT

The following description is structured as follows: After defining notations (section 1) and recalling the problem of set-membership state estimation (section 2), a computationally efficient state set estimation method based on constrained zonotopes (C-zonotopes) will be described (section 3). Then three practical applications of the method will be given as examples:
a simple 1D example (section 4),
a slightly more involved 2D localization problem (section 5),
a 3D peer-to-peer localization benchmark problem using differential GNSS and peer-to-peer ranging observations (section 6).

### 1. Notations

To accommodate this complexity, the notation x(tₗ) familiar from continuous-time estimation theory will be used hereinafter. The discrete nature of filter execution is captured by indexing the time. Specifically, tₖ designates the time for which a priori and a posteriori state sets are computed by the processing unit. For a vector x(t), the time t indicates the time of validity of this vector.

Correspondingly, a set Z(tₖ) is valid at time tₖ, i.e. x(t)∈Z(tₖ) if t=tₖ. If the time of validity is an interval [tₖ], the set is valid for all times in this interval, i.e. x(t)∈Z(tₖ) if t∈[t].

Besides, a matrix J_{n×m} denotes a matrix of n rows and m columns where all elements are one. The identity matrix of size n is denoted by Iₙ and a square zero matrix of size n by 0ₙ.

The dot product of two vectors a, b is denoted <a, b>.

Interval matrices are denoted by [M]=[M,M̅] where the elements of M,M̅∈ [symbol] ^{n×m} are real lower and upper bounds, respectively, of the interval element of [M]. For m=1 and n>1 we speak of an interval vector, i.e. [p]. Scalar intervals are denoted by [x]=[x,x̅] where lower and upper bounds x,x̅∈ [symbol] . For an interval [M], M denotes a realization of the interval, i.e. M∈[M].

Where additive errors are assumed, it can be more convenient to write interval matrices in center-range notation as [M]=mid(M)+[−rad(M),rad(M)], where mid(M) is the center point of [M] and the interval radius matrix is given by rad(M)=M̅−mid(M). Wherever terms and interval terms appear in the same expression, such as [c]=a+[b], it is assumed that the terms (a) represent degenerate intervals ([a, a]) and all operations in the expression are interval operations.

As C-zonotopes are not closed under nonlinear transforms, first order Taylor approximations of nonlinear system equations are used in the following, see sections 3.2 and 3.3. To ensure that these approximations do not compromise the consistency of the resulting state enclosures, the concept of linear inclusion is used, as do other set estimation approaches, see e.g. “A nonlinear set-membership filter for online applications”, by E. Scholte et al. A linear inclusion of a nonlinear function is a set-valued linear function that is guaranteed to contain the solution of the nonlinear function over a certain input set. As an example, consider the function

$$y = h ( x ) \qquad ( 1 )$$

With x∈X, i.e. x is contained in some compact set X. A linear function

$$\hat{y} = {y}_{0} + Hx + ϵ \qquad ( 2 )$$

is a linear inclusion of equation 1 if

$$y ∈ {y}_{0} + Hx + [ ϵ ] \qquad ( 3 )$$

for all x∈X, i.e. the set-valued solution [ŷ] of the linear set valued function always contains the nonlinear solution.

### 2. Problem Statement

A motion of a mobile target can be described by a motion state comprising motion data. The motion data may for instance include: a position of the target, a speed of the target, an acceleration of the target, other data, or a combination thereof. The motion state evolves over time when the mobile target moves.

In the following, the mobile target 1 may be referred to as the “system”, and the motion state as the “state” for the sake of simplicity.

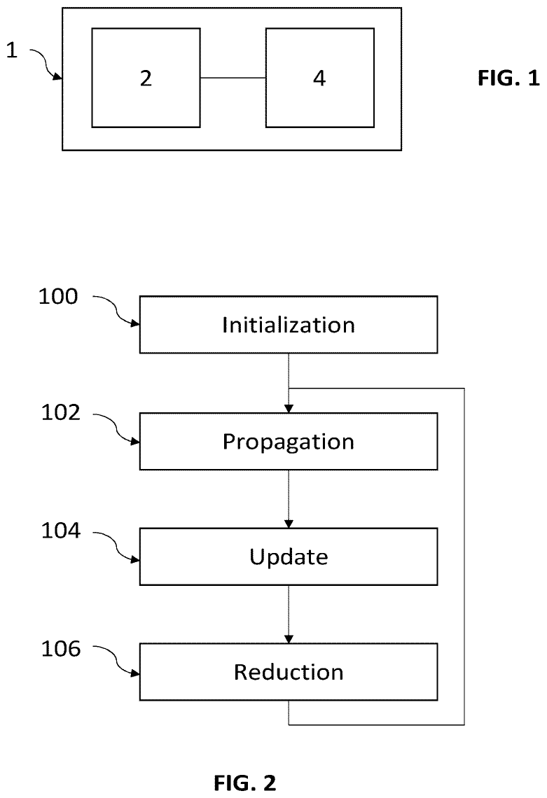

Referring to FIG. 1, a device 1 for estimating a set enclosing the motion state of the mobile target comprises a processing unit 2 and an observation unit 4.

The processing unit 2 is configured to execute a computer program comprising code instructions implementing an estimation method that will be described hereinafter. This computer program will be referred to as the “CZESMF filter” (Constrained Zonotope Extended Set-membership Filter) or “the filter” hereinafter since it actually acts like a filter.

The filter is configured to use a predetermined transition model (also referred to as “propagation model” or “dynamics model” hereinafter) and a predetermined observation model.

The processing unit 2 is configured to operate at different processing moments, such that different sets enclosing the motion state of the mobile target at said different moments can be estimated.

The processing unit 2 can be of any type: one or more processor, one or more microprocessor, FPGA, ASIC, etc.

The observation unit 4 comprises at least one sensor configured to observe the mobile target. The observation unit 4 is therefore configured to output observation data related to the mobile target. The observation unit is also configured to operate at different observation moments, such that different observations can be acquired at said different moments.

The purpose of set-membership state estimation is computing a region X(t)∈ [symbol] ⁿ in which the state x(t) of the system is guaranteed to reside at a time t.

### 2.1. State Dynamics

In discrete state estimation, it is often assumed that the system state dynamics are governed by a static model of the type

$$x ( {t}_{k} ) = f ( x ( {t}_{k - 1} ) , u ( {t}_{k - 1} ) ) + q ( {t}_{k - 1} ) \qquad ( 4 )$$

with the previous state x(tₖ₋₁)∈ [symbol] ⁿ, the system input u(tₖ₋₁)∈ [symbol] ^{p}, the propagation model error q(tₖ₋₁)∈ [symbol] (tₖ₋₁)⊆ [symbol] ⁿ, and a constant sampling time Tₛ=tₖ−tₖ₋₁.

In practice, irregular observation times lead to irregular sampling times, i.e. propagation horizons in the filter. Depending on the sampling time, different propagation models may yield state enclosures of differing tightness. A practical example from navigation is inertial dead-reckoning localization, where the double integration of observed accelerations yields very tight short-term position enclosures, but sensor biases lead to quadratic growth of position enclosures in the long term. In contrast, a simple velocity-norm bound model of vehicle dynamics (see section 5 for an example) leads to linear growth of position enclosures over time, thus possibly providing tighter enclosures for longer propagation horizons.

Another example is treated in section 6, where tight relative position propagations using time differential GNSS phase observations are available only at the GNSS receiver's sampling times, while in between GNSS observations only a crude velocity-norm bound propagation model is available.

We accommodate multiple propagation models by assuming a very general time-varying state dynamics model that is a nonlinear map [symbol] ⁿ× [symbol] ^{p}× [symbol] × [symbol] → [symbol] ⁿ

$$x ( {t}_{k} ) = f ( x ( {t}_{k - 1} ) , u ( {t}_{k - 1} ) , {t}_{k - 1} , {t}_{k} ) + q ( {t}_{k - 1} ) \qquad ( 5 )$$

The arguments tₖ and tₖ₋₁ indicate that the model performs a propagation of the system state over the time horizon from tₖ₋₁ to tₖ as well as the time-varying nature of f( ). Thanks to the propagation model being allowed to be time-varying, the filter can employ the least conservative one from a bank of available models at each propagation step 102 (see FIG. 2).

### 2.2. Observations

In practice, observations made by the observation unit 4 are often nor perfectly synchronous nor perfectly periodic. As a further complication, the observation times may only be approximately known, e.g. due to lack of hard-real-time communication protocols.

Observation time uncertainty leads to a subtle but serious issue not addressed by existing set-membership state estimation schemes. Propagated state enclosures are guaranteed to contain the state only at the selected propagation time tₖ. We call this the time of validity of a given state enclosure \hat{Z}ₓ(tₖ). Since an observation corresponds to some unknown time within an interval, updating the a priori enclosure with this observation leads to a state enclosure that is not guaranteed to be valid at any time, even if tₖ falls within the observation time interval. This is simply due to the fact that \hat{Z}ₓ(tₖ) and the state space constraints corresponding to the observation do not concern the same point in time. Neglecting observation time uncertainty so leads to invalid state enclosures after only one update. A remedy for this issue is presented hereinafter.

The observations are assumed to be governed by the nonlinear map [symbol] ⁿ× [symbol] ^{p}× [symbol] → [symbol] ^{m(t)+1}

$$( \begin{matrix}y ( t ) \\ {\hat{t}}_{y} ( t )\end{matrix} ) ( \begin{matrix}h ( x ( t ) , u ( t ) , t ) + w ( t ) \\ t + {w}_{t} ( t )\end{matrix} ) \qquad ( 6 )$$

$$( \begin{matrix}{y}_{1} ( t ) \\ ⋮ \\ {y}_{m ( t )} ( t ) \\ {\hat{t}}_{y} ( t )\end{matrix} ) = ( \begin{matrix}h ( x ( t ) , u ( t ) , t ) + w ( t ) \\ ⋮ \\ {h}_{m ( t )} ( x ( t ) , u ( t ) , t ) + w ( t ) \\ t + {w}_{t} ( t )\end{matrix} ) \qquad ( 7 )$$

Where y(t)∈ [symbol] ^{m(t)} is a vector of sensor observations, w(t)∈W is the corresponding measurement error, \hat{t}_{y}(t) is the observed observation time stamp, wₜ(t)∈[wₜ] is the observation time error and t is the true observation time. The observation time stamp error wₜ(t) covers not only timing jitter but also communication delays e.g. due to package encoding/decoding delay over a digital data link. All times are wallclock time.

Note that no assumptions are made about the measurement model error other than its being contained in some known set W(t). As such, it covers hardware noise, biases and modeling errors. Note also that both the observation model h( . . . ) and the size m(t) of the observation vector can be time-varying.

While y(t) denotes observations provided by the model, actual measurements received from sensors are denoted by z(t).

### 3. Extended Set-Membership Filter Based on C-Zonotopes

The most popular computationally efficient set representations used in set state estimation are linear transformations of basic geometric entities, such as ellipsoids—transformed unit hyperballs—and zonotopes—transformed unit hypercubes. The inherent symmetry of both the hyperball and the hypercube limits both the ellipsoid's and the zonotope's ability to tightly approximate asymmetric or generally irregularly shaped sets. Further aggravating the situation, both are not closed under the intersection operation of the filter update. As a consequence, outer approximations of the result of each intersection need to be computed. Constrained zonotopes mitigate both of these issues. They are linear transformations of a constrained unit hypercube and as such can be asymmetric. They are closed under intersection, i.e. the intersection of two C-zonotopes is another C-zonotope, although of higher complexity.

A C-zonotope Z={G, c, A, b}⊂ [symbol] ⁿ is defined by its generator matrix G, its center c and the constraint parameters A, b of the unit hypercube, and describes the set

$$Z = \{ G ξ + c \vert {‖ ξ ‖}_{∞} \leq 1 , A ξ = b \} \qquad ( 8 )$$

Each constraint represents a plane intersecting the unit hypercube. The resulting intersection is then projected via the generator matrix G and finally translated by the center vector c.

C-zonotopes are an alternative parameterization of convex polytopes. Besides, C-zonotopes are a superset of regular zonotopes, as each C-zonotope without constraints is a regular zonotope. For briefness and in accordance with the existing literature, the C-zonotope representation of a convex polytope is denoted as G-rep. and their half-space representation as H-rep.

The interval enclosure of a C-zonotope Z is denoted by [Z] and the G-rep. of an interval [a] by Z([a]).

Referring to FIG. 2, a method for estimating a C-zonotope enclosing the state x of the system comprises the following main steps carried by out by the filter, based on a predetermined C-zonotope Zₓ(tₖ₋₁) enclosing the state at time tₖ₋₁:
a propagation step 102 wherein the predetermined C-zonotope is processed so as to obtain an a priori C-zonotope \hat{Z}x(tₖ) enclosing the state at time tₖ;
an update step 104 wherein the a priori constrained zonotope \hat{Z}x(tₖ) is combined with observation data acquired by the observation unit 4 so as to obtain an a posteriori C-zonotope Z′ₓ(tₖ) enclosing the state at time tₖ.

The a posteriori C-zonotope enclosing the state x at the time tₖ and taking into account all observations up to and including tₖ is denoted as

$${Z}_{x}^{′} ( {t}_{k} ) = \{ {G}_{x}^{′} ( {t}_{k} ) , {c}_{x}^{′} ( {t}_{k} ) , {A}_{x}^{′} ( {t}_{k} ) , {b}_{x}^{′} ( {t}_{k} ) \} \qquad ( 9 )$$

While the a priori C-zonotope enclosing the state x at the time tₖ, before performing the update, is denoted by

$${\hat{Z}}_{x} ( {t}_{k} ) = \{ {\hat{G}}_{x} ( {t}_{k} ) , {\hat{c}}_{x} ( {t}_{k} ) , {\hat{A}}_{x} ( {t}_{k} ) , {\hat{b}}_{x} ( {t}_{k} ) \} \qquad ( 10 )$$

It will be detailed below that the propagation step 102 and the update step 104 may use a linear transition model and a linear observation model, respectively, said linear models being obtained by linearizing nonlinear models at specific points.

Moreover, the method may further comprise a reduction step 106 wherein the filter converts the a posteriori C-zonotope Z′ₓ(tₖ) into another C-zonotope Zₓ(tₖ) of lower complexity but containing the C-zonotope Z′ₓ(tₖ).

The propagation step 102, the update step 104 and the reduction step 106 are repeated recursively. More precisely, the method comprises multiple recursions, each recursion performing the propagation step 102, the update step 104 and the reduction step 106.

The very first recursion of the method is preceded by an initialization step 100 wherein the initial C-zonotope \hat{Z}ₓ(tₖ) is determined.

Steps 100, 102, 104 and 106 will now be described in detail.

### 3.1. Initialization

The initial state is known to be contained in some C-zonotope \hat{Z}ₓ(tₖ), the first a priori state enclosure.

### 3.2. Propagation

At the propagation step 102, executed for k>1, the filter computes the a priori state set \hat{Z}ₓ(tₖ). It is guaranteed to contain the state at time tₖ>tₖ₋₁, given the preceding a posteriori state set Zₓ(tₖ₋₁).

As a particularity of uncertain observations, the question of how to choose the time for which to compute the a priori C-zonotope arises. It can even lie in the future at the time when a filter recursion is started, to compensate for filter execution time. Depending on the execution time of the recursion (propagation and update), it can however make more sense to set tₖ close to the observation time and perform a final propagation to compensate for execution time.

Some options are a nominal, periodic observation time, if observations are nominally periodic, or the center of observation time intervals. As a beneficial effect of the first choice, filter results become periodic, hiding the observation time uncertainty inside the filter.

Since C-zonotopes are not closed under nonlinear maps, we start, analogous to an Extended Kalman Filter (EKF), by forming a first order Taylor approximation of the state dynamics model equation (5) about an operating point \hat{x}(tₖ₋₁), û(tₖ₋₁). The centers of the interval enclosure of the preceding a posteriori state and input enclosures are chosen as operating point:

$$\hat{x} ( {t}_{k - 1} ) = mid ( [ {Z}_{x} ( {t}_{k - 1} ) ] ) \qquad ( 11 )$$

$$\hat{u} ( {t}_{k - 1} ) = mid ( [ {Z}_{u} ( {t}_{k - 1} ) ] ) where {Z}_{u} = \{ {G}_{u} , {c}_{\underline{u}} , {A}_{\underline{u}} , {b}_{u} \} \qquad ( 12 )$$

Since C-zonotope centers do not even necessarily lie within their C-zonotope, this choice tends to lead to smaller, but does not minimize linearization errors.

Linearization leads us to the familiar first order Taylor expansion

$$\begin{matrix}x ( {t}_{k} ) = f ( \hat{x} ( {t}_{k - 1} ) , \hat{u} ( {t}_{k - 1} ) , {t}_{k} , {t}_{k + 1} ) + q ( {t}_{k - 1} ) \\ + F ( {t}_{k - 1} ) ( x ( {t}_{k - 1} ) - \hat{x} ( {t}_{k - 1} ) ) + B ( {t}_{k - 1} ) u ( {t}_{k - 1} ) - \hat{u} ( {t}_{k - 1} ) ) \\ + q ( {t}_{k - 1} ) + {ε}_{f} f ( {t}_{k - 1} )\end{matrix} \qquad ( 13 )$$

$$= F ( {t}_{k - 1} ) x ( {t}_{k - 1} ) + B ( {t}_{k - 1} ) u ( {t}_{k - 1} ) + q ( {t}_{k - 1} ) + {ε}_{f} f ( {t}_{k - 1} ) + {c}_{f} ( {t}_{k - 1} ) \qquad ( 14 )$$

Where the linearization error is ϵ_{f}(tₖ)∈[ϵ_{f}(tₖ)] and with

$$F ( {t}_{k} ) = \frac{\partial f}{\partial x} {\vert}_{x = \hat{x} ( {t}_{k - 1} )} , B ( {t}_{k} ) = \frac{\partial f}{\partial u} {\vert}_{\cdot u = \hat{u} ( {t}_{k - 1} )} \qquad ( 15 )$$

$${c}_{f} ( {t}_{k - 1} ) = f ( \hat{x} ( {t}_{k - 1} ) , \hat{u} ( {t}_{k - 1} ) , {t}_{k} , {t}_{k + 1} ) - F ( {t}_{k - 1} ) \hat{x} ( {t}_{k - 1} ) - B ( {t}_{k - 1} ) \hat{u} ( {t}_{k - 1} ) \qquad ( 16 )$$

The corresponding linear inclusion being given by

$$x ( {t}_{k} ) ϵ F ( {t}_{k - 1} ) {Z}_{x} ( {t}_{k - 1} ) + B ( {t}_{k - 1} ) {Z}_{u} ( {t}_{k - 1} ) + {Z}_{q} ( {t}_{k - 1} ) + Z ( [ {ε}_{f} ( {t}_{k - 1} ) ] ) + Z ( [ {c}_{f} ( {t}_{k - 1} ) ] \qquad ( 17 )$$

a propagation from time tₖ₋₁ to time tₖ is then performed as

$${\hat{Z}}_{x} ( {t}_{k} ) = F ( {t}_{k - 1} ) {Z}_{x} ( {t}_{k - 1} ) + B ( {t}_{k - 1} ) {Z}_{u} ( {t}_{k - 1} ) + {Z}_{q} ( {t}_{k - 1} ) + Z ( [ {ε}_{f} ( {t}_{k - 1} ) ] ) + Z ( [ {c}_{f} ( {t}_{k - 1} ) ] \qquad ( 18 )$$

The matrix multiplication and sum operations in equation 18 are the set operations on C-zonotopes defined in “Constrained zonotopes: A new tool for set-based estimation and fault detection”, by J. K. Scott et al. The linearization error and the model uncertainty of the nonlinear state dynamics model are enclosed by Z_{q}(tₖ₋₁) and Zᵤ(tₖ₋₁) is a C-zonotope enclosure of any uncertain input. The propagation uncertainty term q(tₖ) actually corresponds to the process noise of an EKF, and the C-zonotope Z_{q}(tₖ) corresponds to the process noise covariance matrix Q of an EKF.

[ϵ_{f}(tₖ)] can be regarded as a set of transition linearization errors at different elements of C-zonotope Zₓ(tₖ₋₁). A transition linearization error at a given element of Zₓ(tₖ₋₁) is a difference between an output resulting from applying the nonlinear transition model to the given element and an output resulting from applying the linear transition model to the given element.

Besides, the expression Z_{q}(tₖ₋₁)+Z([ϵ_{f}(tₖ₋₁)])+Z([c_{f}(tₖ₋₁)] above mentioned may be regarded as a C-zonotope that contains all the linearization errors. Moreover, the expression F(tₖ₋₁)Zₓ(tₖ₋₁)+B(tₖ_{₁})Zᵤ(tₖ₋₁) can be regarded as a C-zonotope resulting from applying the linear transition model to Zₓ(tₖ₋₁). The a posteriori zonotope is the sum of both expressions.

### 3.2.1. Conditional Propagation

In recursive filtering schemes, the purpose of the propagation step 102 is to obtain a state enclosure that is valid at the time—or in our case close to—the time when observation about the system's state are made.

In the present method, there are two situations where a propagation does not need to be performed, reducing filter run time.

The first situation occurs when performing updates 104 over a sequence of synchronous vector observations. In this case, the a posteriori C-zonotope resulting from the update 104 with the first vector element can be re-used as a priori C-zonotope for the following sequential updates with the remaining elements of the observation vector.

Besides, when observations arrive close in time, instead of performing a propagation, it can be acceptable (in terms of added conservatism), to inflate the observation interval (see section 3.3.1) more, to extend the observation's time of validity over that of the preceding a posteriori C-zonotope. To accommodate this condition, a threshold at Δ̅t̅≥0 is used by the filter. Before each propagation, the filter determines whether a propagation needs to be performed.

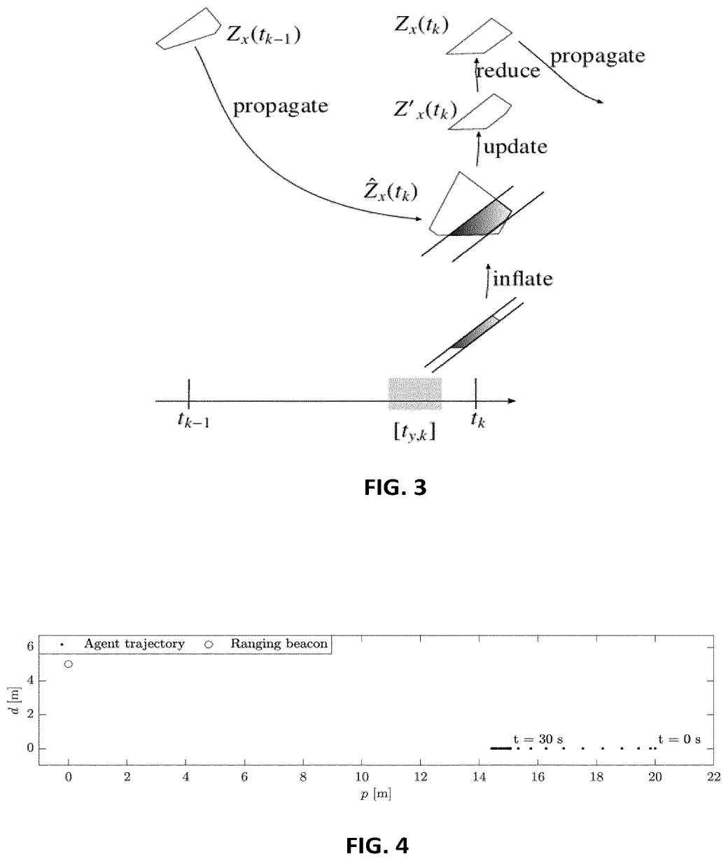

Algorithm 1 below illustrates how a conditional propagation can be implemented in practice: (see also FIG. 3):

Algorithm 1: conditionalPropagation

| | Input : Δ̅t̅, [t_{y,k}], tₖ₋₁ |
|---|---|
| | Output: performPropagation |
| 1 | [symbol] Test for closeness |
| 2 | if sup(tₖ₋₁ − [t_{y,k}]) ≤ Δ̅t̅) then |
| 3 | \| performPropagation = false |
| 4 | else |
| 5 | \| performPropagation = true |
| 6 | [symbol] Test for observation synchronicity |
| 7 | if [t_{y,k}] == [t_{y,k-1}]) then |
| 8 | \| performPropagation = false |

### 3.3. Update

To perform the update, the nonlinear observation equation is linearized to form a linear inclusion of it. By evaluating the remainder (i.e. the linearization error) by Interval Arithmetic (IA), it is guaranteed to be valid over the a priori state enclosure. Each element of the observation vector then defines a strip in state space. The a priori C-zonotope can either be intersected with all these strips at once or sequentially. Popular set formalisms such as ellipsoids and zonotopes are not closed under intersection with a strip, and as such require an outer approximation of each intersection result, which renders the sequential intersection suboptimal. On the other hand, with sequential updates, re-linearization of the observation equation after each intersection can lead to significantly tighter updates due to tightened linearization error intervals. The result of these two opposing effects depends on the degree of nonlinearity of the observations involved and as such is application-dependent.

As an unique feature of C-zonotopes, they are closed under intersection with a strip. In consequence, updating with the whole observation vector at once or sequentially with each scalar element are equivalent operations. As a consequence, using C-zonotopes we can benefit from both effects: the simplicity of sequential updates without loss of intersection optimality and the tightening effect of re-linearization.

Without loss of generality, scalar observations are therefore considered in the following. Vectors of synchronous observations are converted into a sequence of scalar observations with identical timestamps before running the filter recursion. Thus, in the following, the simpler scalar observation equation is taken as an example:

$$( \begin{matrix}y ( {t}_{y , k} ) \\ {\hat{t}}_{y} ( {t}_{y , k} )\end{matrix} ) ( \begin{matrix}h ( x ( {t}_{y , k} ) , u ( {t}_{y , k} ) , t ) + w ( {t}_{y , k} ) \\ {t}_{y , k} + {w}_{t} ( {t}_{y , k} )\end{matrix} ) \qquad ( 19 )$$

Where t_{y,k} is the true observation time of observation k and t_{t,k} is the apparent observation time subject to timing error.

Assuming interval-valued errors, a first-order approximation of the nonlinear observation map valid at time t_{y,k} has the form

$$y ( {t}_{k} ) = h ( \hat{x} ( {t}_{x , k} ) , \hat{u} ( {t}_{x , k} ) , {t}_{x , k} ) + H ( {t}_{k} ) ( x ( {t}_{k} ) - \hat{x} ( {t}_{k - 1} ) ) + D ( {t}_{k} ) ( u ( {t}_{k} ) - \hat{u} ( {t}_{k} ) ) + w ( {t}_{k} ) + {ε}_{h} f ( {t}_{k} ) \qquad ( 20 )$$

$$= H ( {t}_{k} ) x ( {t}_{k} ) + D ( {t}_{k} ) u ( {t}_{k} ) + {ε}_{h} f ( {t}_{k} ) + {c}_{h} ( {t}_{k} ) \qquad ( 21 )$$

$$With$$

$${{H ( {t}_{k} ) = \frac{\partial h}{\partial x} \vert}_{\cdot x = \hat{x} ( {t}_{k} )} , D ( {t}_{k} ) = \frac{\partial h}{\partial u} \vert}_{\cdot u = \tilde{u} ( {t}_{k} )} \qquad ( 22 )$$

$$\hat{x} ( {t}_{k} ) = m i d ( [ {\hat{Z}}_{x} ( {t}_{k} ) ] ) \qquad ( 23 )$$

$$\hat{u} ( {t}_{k} ) = mid ( [ {\hat{Z}}_{u} ( {t}_{k} ) ] ) \qquad ( 24 )$$

$${c}_{h} ( {t}_{k} ) = h ( \hat{x} ( {t}_{x , k} ) , \hat{u} ( {t}_{x , k} ) , {t}_{x , k} ) - H ( {t}_{k} ) \hat{x} ( {t}_{k - 1} ) - D ( {t}_{k} ) \hat{u} ( {t}_{k} ) + w ( {t}_{k} ) \qquad ( 25 )$$

where ϵₕ(tₖ)=ϵ_{h,x}(tₖ)+ϵ_{h,u}(tₖ)∈[ϵₕ(tₖ)] is the linearization error over the a priori states \hat{Z}ₓ and inputs Zᵤ. Note that tₖ is the time of validity of the a priori C-zonotope. The corresponding linear inclusion is then given by

$$y ( {t}_{k} ) ∈ H ( {t}_{k} ) {Z}_{x} ( {t}_{k} ) + B ( {t}_{k - 1} ) {Z}_{u} ( {t}_{k} ) + {Z}_{q} ( {t}_{k} ) + Z ( [ {ε}_{h} ( {t}_{k} ) ] ) + Z ( [ {c}_{h} ( {t}_{k} ) ] \qquad ( 26 )$$

In fact, a linear observation equation and a set that contains the error of this linear equation for all states that are in the a priori C-zonotope are computed here. This error has multiple components:
D(tₖ)Zᵤ(tₖ): The impact of system inputs, e.g. control inputs generated by an autopilot or external perturbations. The C-zonotope Zᵤ contains all possible inputs or perturbations.
Z[ϵₕ(tₖ)]: The linearization error interval converted into a C-zonotope. This zonotope contains all observations errors at different elements of the a priori zonotope. An observation linearization error at a given element of the a priori zonotope is a difference between an output resulting from applying the nonlinear observation model to the given element and an output resulting from applying the linear observation model to the given element.
Z([cₕ(tₖ)]): a C-zonotope that represents all the constant terms of the linearized observation equation and the measurement noise interval of the original, nonlinear observation equation.

To perform the update two sets are intersected. The first one is given by the a priori C-zonotope (equation 18). The second one (see equation 35) is defined by the observation. Since we know that the observation z(t_{y,k}) is contained in the right side of equation 26, we can replace y(t_{y,k}) by z(t_{y,k}) in equation 26 to form equation 35. For a scalar observation, equation 35 then represents a strip in state space, see FIG. 3. Obviously, the second set is not a C-zonotope, since it is not closed (the strip runs infinitely). However, its intersection with the a priori C-zonotope is a C-zonotope (the a posteriori C-zonotope).

Note that while the linearized system equations are an approximation, the corresponding linear inclusions are guaranteed to contain the corresponding nonlinear solutions.

### 3.3.1. Observation Interval Inflation

Recall that the true observation time is known with bounded uncertainty, i.e. is known to fall within an interval [t_{y,k}]. In other words, the observation is valid somewhere within this time interval. Since the times of validity of the observations and the a priori C-zonotope are not guaranteed to coincide, the update may not be performed.

As a simple approach to remedy this situation, the observation error interval [ϵₜ_{ₖ}] is inflated, extending an observation's time of validity. Starting from the linear inclusion equation 26, the time between the time of validity of the a priori C-zonotope and the observation is bounded by the interval

$$[ Δ {t}_{k} ] = {t}_{k} - [ {t}_{y , k} ] \qquad ( 27 )$$

With a state increment interval

$$[ Δ x ( {t}_{k} ) ] \qquad ( 28 )$$

$$that satisfies$$

$$x ( t ) ∈ {\hat{Z}}_{x} ( {t}_{k} ) + Z [ Δ x ( {t}_{k} ) ] \qquad ( 29 )$$

$$if$$

$$t ∈ {t}_{k} + [ {t}_{y , k} ] \qquad ( 30 )$$

we can compute an extended linear inclusion

$$y ( {t}_{y , k} ) ∈ H ( {t}_{k} ) {Z}_{x} ( {t}_{k} ) + D ( {t}_{k} ) {Z}_{u} ( {t}_{k} ) + {Z}_{q} ( {t}_{k} ) + Z ( [ {ε}_{h} ( {t}_{k} ) ] ) + Z ( [ {c}_{h} ( {t}_{k} ) ] + Z ( H ( {t}_{k} ) [ Δ x ] ) \qquad ( 31 )$$

The main objective of the inflation step is to solve the following problem: the time of validity of the observations is not guaranteed to coincide with the time of validity of the a priori C-zonotope. The basic idea to solve it is to inflate the observation error interval to ensure that its time of validity includes the time of validity of the a priori C-zonotope. This is obtained by computing an upper bound of the state variation (equation 28) between the observation time and the time of validity (equation 27) of \hat{Z}ₓ(tₖ). Then all known terms are grouped together into one inflated observation error interval leading to equation 32, which can be used by the filter in the update step 104 (equation 36).

All known terms are lumped together into one inflated observation error interval, simplifying to

$$y ( {t}_{y , k} ) ∈ H ( {t}_{k} ) {Z}_{x} ( {t}_{k} ) + Z ( [ {ε}^{′} ] ) \qquad ( 32 )$$

$$where ( [ {ε}^{′} ] ) = D ( {t}_{k} ) [ {Z}_{u} ( {t}_{k} ) ] + [ {ε}_{h} ( {t}_{k} ) ] + [ {c}_{h} ( {t}_{k} ) ] + H ( {t}_{k} ) [ Δ x ] )$$

Note that the linearization error ϵₕ(tₖ) now needs to be computed over the inflated a priori state set \hat{Z}ₓ(tₖ)+Z[Δx(tₖ)]. For implementation, ϵₕ(tₖ) can be evaluated over the interval enclosure [\hat{Z}ₓ]+[Δx] to be able to use interval arithmetic. This is generally faster than choosing the alternative interval \hat{Z}ₓ+Z[Δx] due to the increase in C-zonotope complexity involved in the C-zonotope sum operation.

With the scalar observation z(t_{y,k}) we then have

$$z ( {t}_{y , k} ) ∈ H ( {t}_{k} ) {Z}_{x} ( {t}_{k} ) + Z ( [ {ε}^{′} ] ) \qquad ( 33 )$$

$$and$$

$$H ( {t}_{k} ) {Z}_{x} ( {t}_{k} ) ∈ z ( {t}_{y , k} ) - Z ( [ {ε}^{′} ] ) \qquad ( 34 )$$

$$∈ Z ( [ ε ] ) \qquad ( 35 )$$

with [ϵ]=z−[ϵ′] and where Z([ϵ])={rad([ϵ]), mid([ϵ]), 0,0} is the G-rep. of the interval [ϵ].

$${Z}_{x}^{′} ( {t}_{k} ) = {\hat{Z}}_{x} ( {t}_{k} ) {⋂}_{H} Z ( [ ε ] ) \qquad ( 36 )$$

$$= \{ {G}_{x}^{′} ( {t}_{k} ) , {c}_{x}^{′} ( {t}_{k} ) , {A}_{x}^{′} ( {t}_{k} ) , {b}_{x}^{′} ( {t}_{k} ) \} \qquad ( 37 )$$

$$With$$

$${G}_{x}^{′} ( {t}_{k} ) = [ \begin{matrix}{\hat{G}}_{x} ( {t}_{k} ) & 0\end{matrix} ] \qquad ( 38 )$$

$${c}_{x}^{′} ( {t}_{k} ) = {\hat{c}}_{x} ( {t}_{k} ) \qquad ( 39 )$$

$${A}_{x}^{′} ( {t}_{k} ) = [ \begin{matrix}{\hat{A}}_{x} ( {t}_{k} ) & 0 \\ H ( tk ) {\hat{G}}_{x} & - rad ( [ ε ] )\end{matrix} ] \qquad ( 40 )$$

$${b}_{x}^{′} ( {t}_{k} ) = [ \begin{matrix}\hat{b} ( {t}_{k} ) \\ id ( [ ε ] ) - H ( {t}_{k} ) \hat{c} ( {t}_{k} )\end{matrix} ] \qquad ( 41 )$$

See FIG. 3 for an overview of the propagation and update timing.

### 3.4. Reduction

As can be seen from equations 36-41, each update increases the complexity—i.e. the number of generators n_{g} and the number of constraints n_{c}—of the state C-zonotope. To control computational complexity and memory footprint, the filter performs a reduction after the update if the complexity of Zₓ(tₖ) exceeds a certain chosen complexity threshold defined by n̅_{g},n̅_{c}.

Algorithm 2 below illustrates how the reduction step 106 can be implemented in practice:

Algorithm 2: reduce

| | Input : Z′ₓ(tₖ), n̅_{g}, n̅_{c} | |
|---|---|---|
| | Output: Zₓ(tₖ) | |
| 1 | if n_{g}(Z′ₓ(tₖ)) > n̅_{g} or n_{c}(Z′ₓ(tₖ)) > n̅_{c} then | |
| 2 | \| | Reduce Z′ₓ(tₖ) to Zₓ(tₖ) by reduction algorithms |
| | \| | given in [19, 25] |
| 3 | else | |
| 4 | \| | Zₓ(tₖ) = Z′ₓ(tₖ) |

Algorithms 3, 4 below illustrate the different steps performed by the filter according to an embodiment.

Algorithm 3: This loop runs until the filter stops executing

| 1 | Compute \hat{Z}ₓ(t₁) with VSIVIA or from a priori | | | |
|---|---|---|---|---|
| | knowledge | | | |
| 2 | k = 1 | | | |
| 3 | Loop | | | |
| 4 | \| | Wait for incoming observation z ∈ [symbol] ^{m} | | |
| 5 | \| | Select propagation time tₖ | | |
| 6 | \| | for i ← 1 to m do | | |
| 7 | \| | \| | if k == 1 then | |
| 8 | \| | \| | \| | Z = \hat{Z}ₓ(t₁) |
| 9 | \| | \| | else | |
| 10 | \| | \| | \| | Z = Zₓ(tₖ₋₁) |

| | | | |
|---|---|---|---|
| 11 | \| | \| | Zₓ(tₖ) = czesmf_recursion(Z, zᵢ) |
| 12 | \|_{—} | \|_{—} | k += 1 |

Algorithm 4: czesmf_recursion

| | Input : Zₓ(tₖ₋₁), z(t_{y,k}) | |
|---|---|---|
| | Output: Zₓ(tₖ) | |
| 1 | if conditionalPropagation(Δ̅t̅, [t_{y,k}], tₖ₋₁) then | |
| 2 | \| | Compute linear inclusion eq. 26 |
| 3 | \| | Compute a priori \hat{Z}ₓ(tₖ) with eq. 18 |
| 4 | else | |
| 5 | \| | \hat{Z}ₓ(tₖ) = Zₓ(tₖ₋₁) |

| | |
|---|---|
| 6 | Compute linear inclusion eq. 26 |
| 7 | Compute inflated observation error interval with eq. 31 |
| 8 | Compute a posteriori Z′ₓ(tₖ) with eq. 36 |
| 9 | Reduce: Zₓ(tₖ) = reduce(Z′ₓ(tₖ), n̅_{g}, n̅_{c}) |

4. 1D application

In this first example, we consider a target device (or agent) whose motion is confined to the x axis of a Cartesian frame, see FIG. 4. We estimate its position p and velocity v based only on range observations to a beacon. The beacon being positioned off the x axis by the distance d renders the observation equation nonlinear and as such requires a nonlinear estimator such as the CZESMF. There is no uncertainty in observation times in this minimal example.

The dynamics of the state x=(p v)^{T} are governed by

$$x ( {t}_{k} ) = [ \begin{matrix}1 & {T}_{s} \\ 0 & 1\end{matrix} ] x ( {t}_{k - 1} ) + ( \begin{matrix}{\int }_{{t}_{k - 1}}^{{t}_{k}} {\int }_{{t}_{k - 1}}^{{t}_{k}} a ( t ) dt dt \\ {\int }_{{t}_{k - 1}}^{{t}_{k}} a ( t ) dt\end{matrix} ) \qquad ( 42 )$$

wherein Tₛ=tₖ−tₖ₋₁ and a(t) is the acceleration.

Range observations are governed by

$$r ( {t}_{y , k} ) = \sqrt{{d}^{2} + {p}^{2} ( {t}_{y , k} )} + {w}_{k} \qquad ( 43 )$$

with wₖ ∈[w]=[−0.224,0.168] m.

### 4.1. Initialization

We assume that initially the target's position and velocity are confined to

$${\hat{Z}}_{x} ( {t}_{1} ) = Z ( \begin{matrix}[ 0 , 1000 ] m \\ [ - 0.7 , 0.7 ] \frac{m}{s}\end{matrix} ) \qquad ( 44 )$$

### 4.2. Propagation

With target accelerations being bounded by

$$a ( t ) ∈ [ a ] = [ - 0 \text{.4} , 0.4 ] \frac{m}{{s}^{2}} and {T}_{s} = {t}_{k} - {t}_{k - 1}$$

an inclusion for x(tₖ) is given by

$$x ( {t}_{k} ) ∈ [ \begin{matrix}1 & {T}_{s} \\ 0 & 1\end{matrix} ] {Z}_{x} ( {t}_{k - 1} ) + [ \begin{matrix}\frac{1}{2} {T}_{s}^{2} \\ {T}_{s}\end{matrix} ] Z ( [ a ] ) \qquad ( 45 )$$

$$∈ F ( {t}_{k - 1} ) {Z}_{x} ( {t}_{k - 1} ) + {Z}_{q} ( {t}_{k - 1} ) \qquad ( 46 )$$

with Z_{q}(tₖ₋₁)=QZ([a]).

Since the inclusion equation 46 is already linear, we obtain the a priori C-zonotope directly as

$${\hat{Z}}_{x} ( {t}_{k} ) = F {Z}_{x} ( {t}_{k - 1} ) + {Z}_{q} ( {t}_{k - 1} ) \qquad ( 47 )$$

### 4.3. Update

Since observations times are without uncertainty in this example, tₖ=t_{y,k}, i.e. we propagate the state enclosure to the observations' time of validity. From equation 43 is formed the linear inclusion

$$r ( {t}_{k} ) ∈ H ( {t}_{k} ) {Z}_{x} ( {t}_{k} ) + Z ( [ w ] ) + Z ( [ {ϵ}_{h} ] ) + {c}_{h} ( {t}_{k} )$$

$$with$$

$$\begin{matrix}H ( {t}_{k} ) = \frac{\partial r}{\partial x} ( 49 ) \\ = [ \begin{matrix}\frac{{\hat{p}}_{k}}{\sqrt{{d}^{2} + {\hat{p}}_{k}^{2}}} & 0\end{matrix} ] ( 50 ) \\ = [ \begin{matrix}{H}_{p} & {H}_{v}\end{matrix} ] ( 51 )\end{matrix}$$

$$and$$

$${c}_{h} ( {t}_{k} ) = \sqrt{{d}^{2} + {\hat{p}}_{k}^{2}} - H ( {t}_{k} ) \hat{x} ( {t}_{k} ) \qquad ( 52 )$$

When computing an enclosure of the linearization error, the generic approach of evaluating the Lagrange remainder by interval arithmetic often leads to overly conservative enclosures due to dependencies. Evaluating ϵₕ explicitly can provide tighter enclosures, even more so when exploiting monotonicity. An explicit expression of the linearization error is

$${ϵ}_{h} = \sqrt{{d}^{2} + {p}^{2}} - {H}_{p} p - {c}_{h} ( {t}_{k} ) \qquad ( 53 )$$

To check for monotonicity, consider the derivative

$$\frac{\partial {ϵ}_{h} ( p )}{\partial p} = \frac{p}{\sqrt{{d}^{2} + {p}^{2}}} - {H}_{p} \qquad ( 54 )$$

To compute a tight inclusion of ϵₕ over the interval enclosure of the a priori C-zonotope \hat{Z}ₓ(tₖ), we then only need to evaluate its vertices as well as the possible inflection point given by

$$\frac{\partial {ϵ}_{h} ( \overline{p} )}{\partial p} = 0 \qquad ( 55 )$$

$$\overline{p} = \sqrt{\frac{{H}_{p} {d}^{2}}{1 - {H}_{p}^{2}}} \qquad ( 56 )$$

The update is then performed according to equation 36.

### 4.4. Simulations

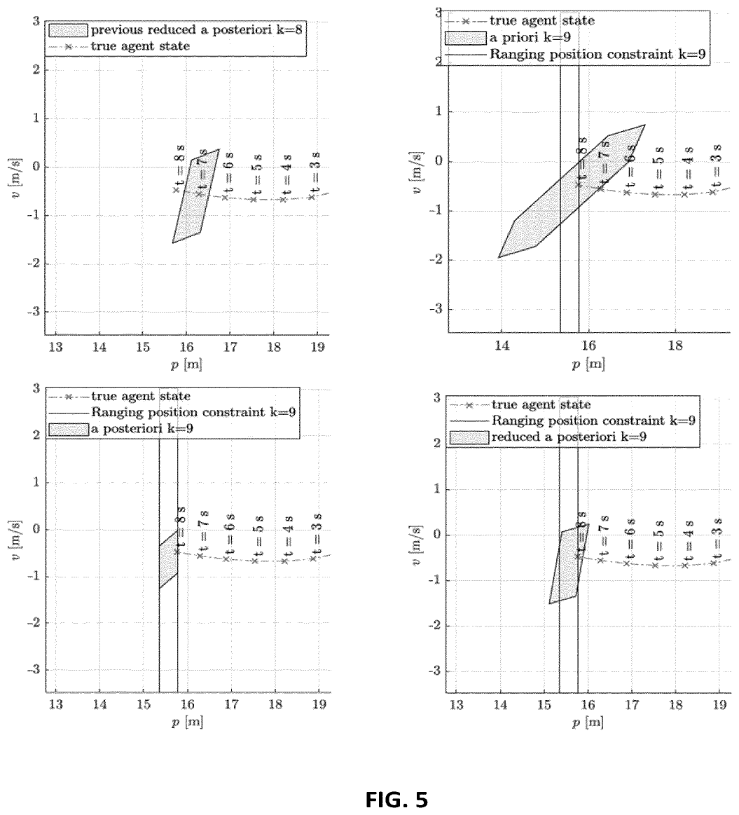

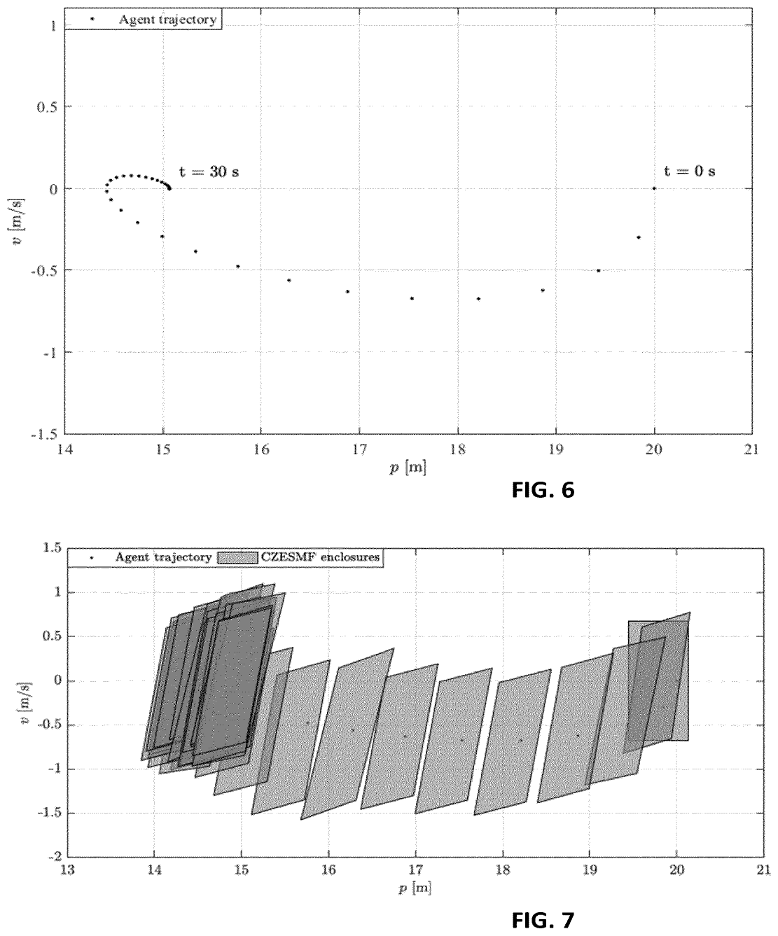

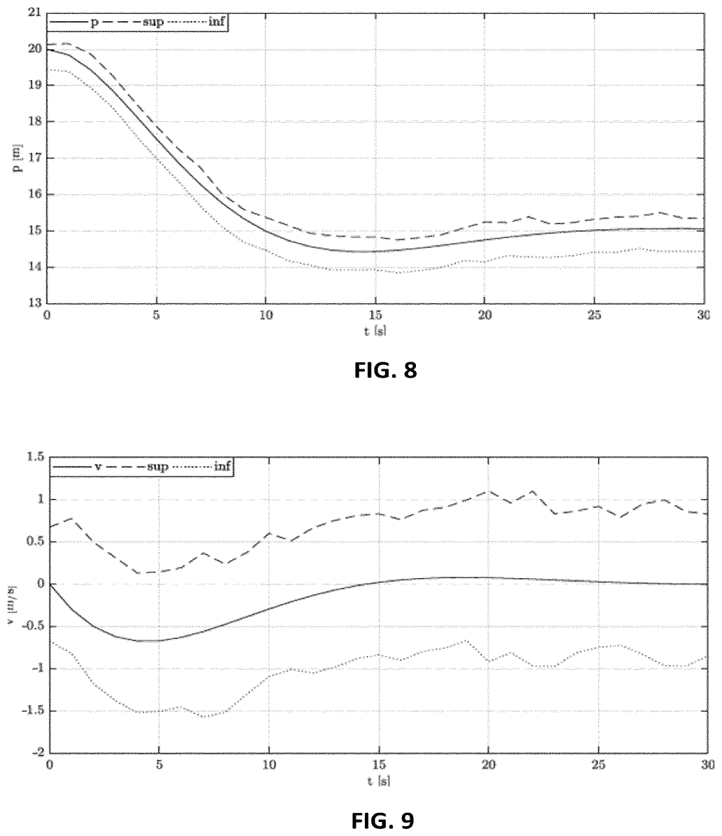

Snapshots of the propagation step 102, update step 104 and reduction step 106 are displayed in FIG. 5. FIGS. 6 and 7 show the true state trajectory and the CZESMF enclosures, respectively. FIGS. 8 and 9 show the corresponding position and velocity interval enclosures, respectively. After each update, state C-zonotopes have been reduced to n̅_{g}=6, n̅_{g}=2.

### 5. 2D Localization Application

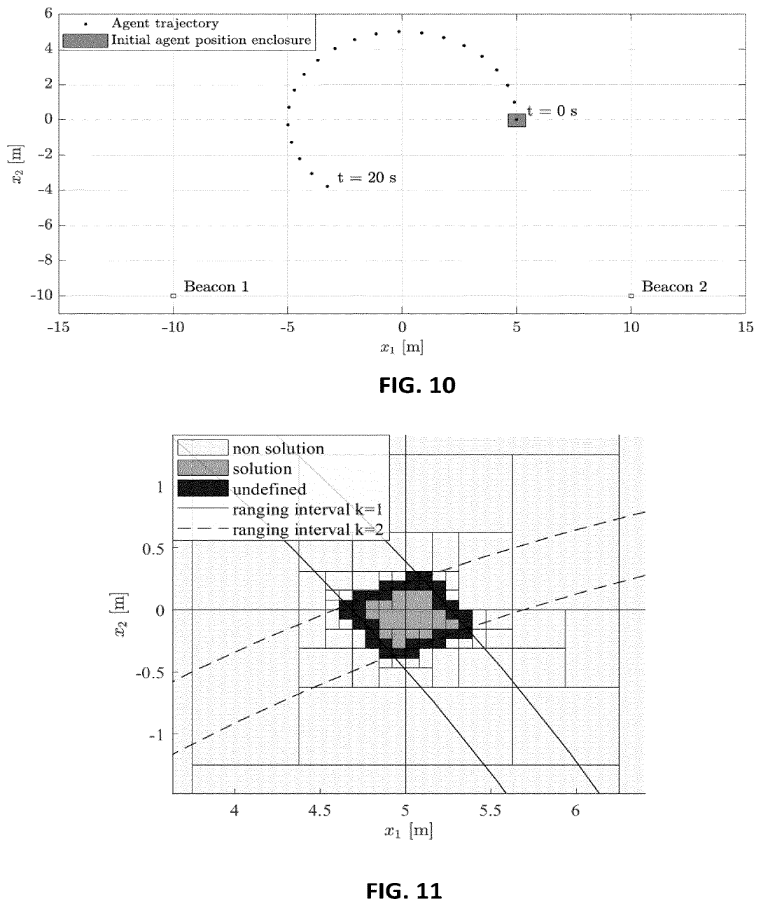

In this example we consider a target device moving on a field with two static ranging beacons (see FIG. 10). This could be an automatic lawnmower required to avoid cutting down flowers within specified zones and to avoid leaving the perimeter of the field or an automatic lift truck in a modern warehouse.

The target's position x=(x₁ x₂)^{T} is governed by

$$x ( {t}_{k} ) = x ( {t}_{k - 1} ) + q ( {t}_{k - 1} ) \qquad ( 57 )$$

$$where$$

$$‖ q ( {t}_{k} ) ‖ \leq \overline{v} ( {t}_{k + 1} - {t}_{k} ) \qquad ( 58 )$$

with the target's maximum velocity v̅. This velocity norm constraint is a conservative but easily obtainable dynamic model for a mobile target device if better knowledge of its inner dynamics is not available.

The target device regularly receives ranging observations to both beacons situated at the uncertain positions

$${p}_{b 1} ∈ ( \begin{matrix}- 10. m \\ - 10. m\end{matrix} ) + {ϵ}_{b} \qquad ( 59 )$$

$${p}_{b 2} ∈ ( \begin{matrix}10. m \\ - 10. m\end{matrix} ) + {ϵ}_{b} \qquad ( 60 )$$

$$with$$

$${ϵ}_{b} ∈ ( \begin{matrix}[ - 0.1 , 0.1 ] m \\ [ - 0.1 , 0.1 ] m\end{matrix} ) \qquad ( 61 )$$

The ranging observation to each beacon iₖ is governed by

$$( \begin{matrix}{r}_{k} \\ {t}_{y , k}\end{matrix} ) = ( \begin{matrix}‖ x ( t ) - {p}_{{bi}_{k}} ‖ \\ t + {w}_{t} ( t )\end{matrix} ) \qquad ( 62 )$$

These two observations are nominally synchronous at a frequency of 1 Hz. Imperfect synchronization of the ranging sensor with wall clock time causes the bounded timing jitter wₜ(t)∈[−10⁻² 10⁻²]s. That is to say, a pair of ranging observations arrives approximately every second, but not exactly.

To obtain periodic state enclosures, the filter recursion is triggered at the upper bound of the observation time intervals, i.e. (t₁, t₂, t₃, t₄, . . . )=(0.01 s, 0.01 s, 1.01 s, 1.01 s, . . . ).

### 5.1. Initialization

The target device is initially inside the field. This allows the computation of a C-zonotope that corresponds to an interval covering the field. This extremely conservative initial enclosure leads however to extremely conservative filter solutions. A tighter enclosure of the initial state is therefore computed with VSIVIA. This one-time step is not very computationally expensive in two dimensions (0.8 s and 233 processed boxes with ϵ=0.1 m). For estimation problems in higher state dimensions, it might be preferable to couple VSIVIA with constraint propagation to compute a sufficiently tight initial state enclosure in an acceptable time.

The C-zonotope corresponding to the interval enclosure of the subpaving (denoted as “solution” and “undefined” in FIG. 11) obtained by VSIVIA is used to initialize the filter.

### 5.2. Propagation

The state dynamics are already linear in the state. The propagation can thus be directly performed by

$${\hat{Z}}_{x} ( {t}_{k} ) = {Z}_{x} ( {t}_{k - 1} ) + {Z}_{s} ( {t}_{k - 1} ) \qquad ( 63 )$$

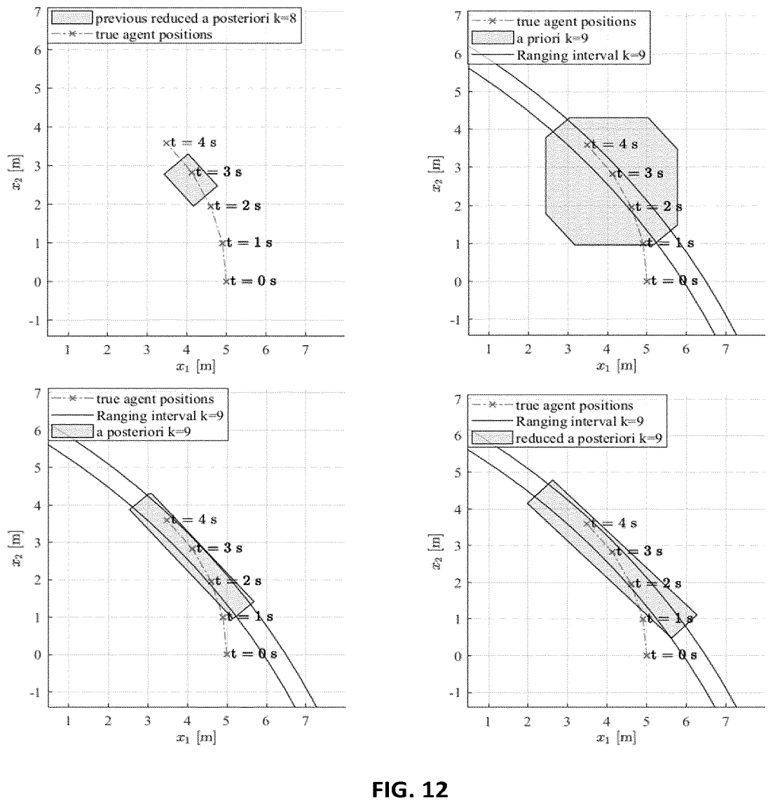

The state dynamics uncertainty ball defined by equation 58 is outer approximated by a C-zonotope (see Appendix A below) to obtain Zₛ(tk−1). An example of the resulting a priori C-zonotope is displayed in FIG. 12. Note how \hat{Z}ₓ(t₉) contains the true position at t₉. Note also that t₉ corresponds to the first propagation-update sequence performed close to t=4 s, since two ranging observations arrive at approximately 1 Hz and every observation increases the filter recursion index k.

### 5.3. Update

It simplifies things to perform each update in the nominal frame of the corresponding ranging beacon iₖ. The a priori C-zonotope in the beacon frame being given by

$${\hat{Z}}_{x}^{b} ( {t}_{k} ) = {\hat{Z}}_{x} ( {t}_{k} ) - {p}_{{bi}_{k}} \qquad ( 64 )$$

each ranging observation is then governed by

$$r ( {t}_{k} ) = ‖ x ( {t}_{k} ) - {ϵ}_{b} ‖ + {w}_{r , k} \qquad ( 65 )$$

To simplify further, we absorb the small beacon uncertainty into the observation error w_{r,k} by virtue of

$$‖ x ‖ - ‖ {ϵ}_{b} ‖ \geq ‖ x - {ϵ}_{b} ‖ \leq ‖ x ‖ + ‖ {ϵ}_{b} ‖ \qquad ( 66 )$$

$$leading to$$

$$r ( {t}_{k} ) = ‖ x ( {t}_{k} ) ‖ + {w}_{r , k}^{′} \qquad ( 67 )$$

$$with$$

$${w}_{r , k}^{′} ∈ [ {w}_{r , n}^{′} ] = [ {w}_{r} ] + [ - rad ( [ {ϵ}_{b} ] ) , rad ( [ {ϵ}_{b} ] ) ] .$$

From equation 67 we form the linear inclusion

$$r ( {t}_{k} ) ∈ H ( {t}_{k} ) {Z}_{x} ( {t}_{k} ) + Z ( [ {w}_{r}^{′} ] ) + Z ( [ {ϵ}_{h} ] ) + {c}_{h} ( {t}_{k} ) \qquad ( 68 )$$

$$with$$

$$H ( {t}_{k} ) = \frac{{\hat{x}}^{T} ( {t}_{k} )}{‖ {\hat{x}}^{T} ( {t}_{k} ) ‖} \qquad ( 69 )$$

$$and$$

$${c}_{h} ( {t}_{k} ) = ‖ {x}_{k} ‖ - H ( {t}_{k} ) \hat{x} ( {t}_{k} ) \qquad ( 70 )$$

### 5.3.1. Observation Interval Inflation

Before compensating for timing jitter, the state increment interval [Δx(tₖ)] is obtained from the velocity norm bound v̅

$$[ Δ x ] = 2 \overline{v} rad ( [ {w}_{t} ] ) [ \begin{matrix}[ - 1 , 1 ] \\ [ - 1 , 1 ]\end{matrix} ] \qquad ( 71 )$$

and the inflated observation inclusion is computed as follows

$$r ( {t}_{y , k} ) ∈ H ( {t}_{k} ) {Z}_{x}^{b} ( {t}_{k} ) + Z ( [ {w}_{r}^{′} ] ) + Z ( [ {ϵ}_{h} ] ) + {c}_{h} ( {t}_{k} ) + H ( {t}_{k} ) Z ( [ Δ x ] ) \qquad ( 72 )$$

After computing the a posteriori C-zonotope

$${Z}_{x}^{b} ( {t}_{k} )$$

in the beacon frame with eqs. 36-41, the a posteriori C-zonotope is translated back to the navigation frame

$${Z}_{x} ( {t}_{k} ) = {Z}_{x}^{b} ( {t}_{k} ) + {p}_{{bi}_{k}} \qquad ( 73 )$$

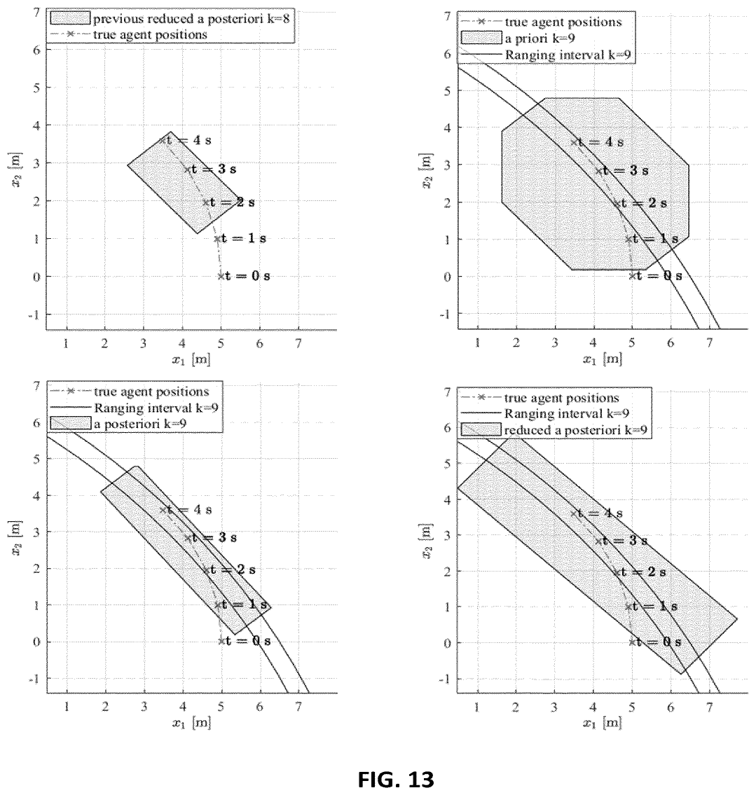

FIG. 12 shows the obtained a posteriori C-zonotope at t₉, as well as the reduced a posteriori C-zonotope. FIG. 13 shows the obtained results with increased timing noise value. Note the larger a posteriori C-zonotope due to increased observation interval inflation.

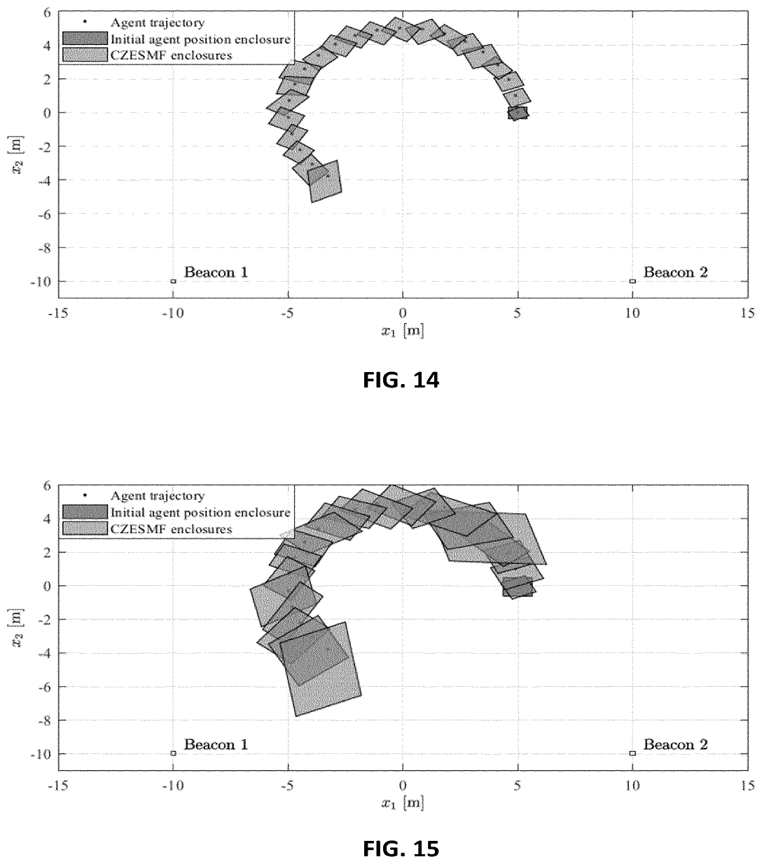

The full state enclosure trajectory is displayed in FIG. 14, and in FIG. 15 for increased observation timing noise. After each update, state C-zonotopes have been reduced to n̅_{g}=15, n̅_{c}=1. By setting Δt to 0.1 s, it is ensured that a propagation is only performed once for every pair of ranging observations, thus reducing filter run time (conditional propagation).

### 6. Application to 3D Peer-to-Peer Localization

In this example, the state of interest is the relative position between two agents, such as unmanned aircraft in close formation flight. Numerous aerospace applications require guaranteed relative positioning, such as aerial refueling, energy efficient formation flight and nanosatellite swarms. In this example, raw GNSS code and carrier phase observations as well as UWB peer-to-peer ranging observations are obtained. Both kinds of sensors are inexpensive, of very low mass—tens of grams—and readily available as Commercial-Off-The-Shelf (COTS) components. We show how the CZESMF can be applied to this localization problem of high practical relevance and evaluate its conservatism in a realistic simulation benchmark in comparison to existing set-membership state estimation schemes.

In the following time indices are dropped wherever unambiguously possible to improve readability.

### 6.1. Initialization

Due to the high degree of linearity of the GNSS code phase double difference observations, the filter can simply be initialized with a very conservative guess about the initial relative position.

### 6.2. Propagation

We propagate the guaranteed relative position x set between two vehicles A and B

$$x = {p}_{B} - {p}_{A}$$

Set-valued dynamic vehicle models of moderate conservatism are rarely available, mostly due to the absence of established set-theoretic system identification methods. A vehicle-agnostic propagation model is therefore highly desirable. Set-membership inertial navigation is one option worthy of further research, but not further explored here. We instead rely on time-differenced GNSS carrier-phase double difference observations, when available, and a rough velocity norm constraint model at times without GNSS observations. Standalone time-differenced carrier phase observations have received originally introduced for precise flight trajectory reconstruction. Building thereon, Time-Differenced Double phase Difference (T3D) observations have first been proposed recently for tight set-valued relative trajectory tracking. The millimeter-level carrier noise allows to compute very narrow enclosures of position increments between GNSS observations. Applied to relative position estimation, propagated state sets are less conservative, leading to smaller linearization error sets in the update step and finally to less conservative a posteriori state sets.

### 6.2.1. T3D Observations

Forming single differences of carrier phase observations removes the majority of atmospheric errors and the satellite clock error.

Single difference carrier phase observations for two receivers A and B and a satellite S are then given by

$$ΔΦ ( {p}_{A} , {p}_{B} , {p}_{S} ) = ‖ {p}_{A} - {p}_{S} ‖ - ‖ {p}_{B} - {p}_{S} ‖ + Δ N λ + {ϵ}_{ΔΦ} + Δ Tc \qquad ( 75 )$$

where ϵ_{ΔΦ} captures residual errors due to hardware noise and multipath, ΔT is the differential receiver clock error, c the speed of light, λ is the carrier wavelength and ΔN the differential carrier cycle ambiguity.

Using d_{S}=p_{A}−p_{S} and p_{B}=p_{A}+x we write more compactly

$$ΔΦ ( x , {d}_{S} ) = ‖ {d}_{S} ‖ - ‖ {d}_{S} + x ‖ + Δ N λ + {ϵ}_{ΔΦ} + Δ Tc \qquad ( 76 )$$

The differential receiver clock error is removed by forming double differences with respect to a reference satellite R

$$∇ Φ ( x , {d}_{S} , {d}_{R} ) = ‖ {d}_{S} ‖ - ‖ {d}_{S} + x ‖ - ‖ {d}_{R} ‖ + ‖ {d}_{R} + x ‖ + {ϵ}_{∇ Φ} + ∇ N λ \qquad ( 77 )$$

Double difference carrier phase observations are thus a nonlinear function of the relative position of receivers A and B and the vectors between absolute receiver positions and satellite orbit positions.

Assuming that the receiver maintains phase lock over two subsequent epochs, the ambiguities are a constant that is eliminated by forming the difference of two subsequent double difference observations, forming the T3D observation

$$Δ ∇ Φ ( {t}_{k} ) = ∇ Φ ( {t}_{k} ) - ∇ Φ ( {t}_{k - 1} ) \qquad ( 78 )$$

In the following we show how we can compute a C-zonotope that encloses the position increment Δx=x(tₖ)−x(tₖ₋₁).

Linearizing (using equation 78) directly and computing an interval enclosure of the Laplace remainder using interval arithmetic as proposed in “A nonlinear set-membership filter for online applications”, by E. Scholte et al. yields very large over-approximation due to heavy dependencies.

This issue is overcome by instead linearizing the single difference equation 76.

The Lagrange remainder is then evaluated using IA and the resulting interval is added to the hardware error interval ϵ_{ΔΦ}.

To simplify the computation of the necessary Jacobian and Hessian it is convenient to write equation 76 as

$$\begin{matrix}ΔΦ = {\sum }_{i = 1}^{2} {s}_{i} ‖ {E}_{i} \tilde{z} ‖ + Δ N λ + {ϵ}_{ΔΦ} + Δ Tc & ( 79 ) \\ = {\sum }_{i = 1}^{2} {{s}_{i} ( {\tilde{z}}^{T} {E}_{i}^{T} {E}_{i} \tilde{z} )}^{1 / 2} + Δ N λ + {ϵ}_{ΔΦ} + Δ Tc & ( 80 ) \\ = {\sum }_{i = 1}^{2} {{s}_{i} ( {\tilde{z}}^{T} {M}_{i} \tilde{z} )}^{1 / 2} + Δ N λ + {ϵ}_{ΔΦ} + Δ Tc & ( 81 )\end{matrix}$$

with the augmented state vector

$$z = {( \begin{matrix}{d}_{S}^{T} & {x}^{T}\end{matrix} )}^{T} \qquad ( 82 )$$

$$and$$

$${E}_{1} [ {I}_{3} {0}_{3} ] , {E}_{2} = [ {I}_{3} {I}_{3} ] , s = [ \begin{matrix}1 & - 1\end{matrix} ] \qquad ( 83 )$$

The Jacobian and Hessian of equation 81 can then conveniently be formed as

$$\begin{matrix}\frac{\partial ΔΦ}{\partial z} = {\sum }_{i = 1}^{2} {( {z}^{T} {M}_{i} z )}^{- 1 / 2} {z}^{T} {M}_{i} & ( 84 ) \\ = [ \begin{matrix}\frac{\partial ΔΦ}{\partial {d}_{S}} & \frac{\partial ΔΦ}{\partial x}\end{matrix} ] & ( 85 ) \\ \frac{\partial ΔΦ}{\partial {z}^{2}} = {\sum }_{i = 1}^{2} {( {z}^{T} {M}_{i} z )}^{- 1 / 2} {M}_{i}^{T} - & ( 86 ) \\ {M}_{i}^{T} {z ( {z}^{T} {M}_{i} z )}^{- 3 / 2} {z}^{T} {M}_{i} & \end{matrix}$$

Interval bounds on the observation model error due to linearization and parametric uncertainty (uncertain orbit position of the satellite) can thus be obtained by evaluating

$$[ {R}_{ΔΦ} ] = \frac{\partial ΔΦ}{\partial {d}_{S}} ( [ {d}_{s} ] - mid ( [ {d}_{s} ] ) ) + {( [ z ] - mid ( [ z ] ) )}^{T} \frac{{\partial }^{2} Δϕ ( [ z ] )}{\partial {z}^{2}} \qquad ( 87 )$$

We proceed to forming the linear single difference observation

$$\begin{matrix}ΔΦ = ΔΦ ( mid ( [ {d}_{S} ] ) , mid ( [ x ] ) ) & ( 88 ) \\ + pdv ΔΦx ( x - mid ( [ x ] ) ) + {R}_{ΔΦ} + {ϵ}_{ΔΦ} + Δ N λ + Δ Tc & ( 89 )\end{matrix}$$

As [R_{ΔΦ}] is generally very narrow, of the order of millimeters, for small separations we can linearize about x=0 and have the more compact form

$$ΔΦ = {H}_{S} x + {ϵ}_{ΔΦ}^{′} + Δ N λ + Δ Tc \qquad ( 90 )$$

familiar from the RTK literature, with ϵ′_{ΔΦ}=ϵ_{ΔΦ}+R_{ΔΦ}+pdvΔΦx(x−mid([x])). We can then form a linear double difference observation model that is free of dependencies

$$\begin{matrix}∇ Φ = ( {H}_{R} - {H}_{S} ) x + {ϵ}_{∇ Φ}^{′} & ( 91 ) \\ = {H}_{∇} x + {ϵ}_{∇ Φ}^{′} & ( 92 )\end{matrix}$$

where ϵ′_{∇Φ} now lumps together observation and linearization errors.

Taking the difference of two consecutive carrier phase observations with observation times tₖ₋₁ and tₖ respectively, the constant ambiguity terms are eliminated. Introducing Δx(tₖ)=x(tₖ)−x(tₖ₋₁), the T3D observation is given by

$$\begin{matrix}Δ ∇ Φ = {H}_{∇} ( {t}_{k} ) x ( {t}_{k} ) - {H}_{∇} ( {t}_{k - 1} ) x ( {t}_{k - 1} ) + {ϵ}_{Δ ∇ Φ} ( {t}_{k} ) & ( 93 ) \\ {H}_{∇} ( {t}_{k} ) x ( {t}_{k} ) - ( {H}_{∇} ( {t}_{k} ) + Δ {H}_{∇} ( {t}_{k} ) ) x ( {t}_{k - 1} ) + {ϵ}_{Δ ∇ Φ} ( {t}_{k} ) & ( 94 ) \\ {H}_{∇} ( {t}_{k} ) Δ x ( {t}_{k} ) = Δ {H}_{∇} ( {t}_{k} ) x ( {t}_{k - 1} ) + {ϵ}_{Δ ∇ Φ} ( {t}_{k - 1} ) & ( 95 ) \\ {H}_{∇} ( {t}_{k} ) Δ x ( {t}_{k} ) + {ϵ}_{Δ ∇ Φ}^{′} ( {t}_{k} ) & ( 96 )\end{matrix}$$

$$with$$

$${ϵ}_{Δ ∇ Φ}^{′} ( {t}_{k} ) ∈ [ {ϵ}_{Δ ∇ Φ}^{′} ( {t}_{k} ) ] \qquad ( 97 )$$

$$[ {ϵ}_{Δ ∇ Φ}^{′} ( {t}_{k} ) ] = [ {ϵ}_{∇ Φ} ( {t}_{k} ) ] - [ {ϵ}_{∇ Φ} ( {t}_{k - 1} ) ] - [ Δ {H}_{∇} ( {t}_{k} ) ] [ x ( {t}_{k - 1} ) ] \qquad ( 98 )$$

We exploit here the fact that the geometry matrix H_{∇} changes very little between two consecutive time steps due to the large distance between receiver and satellites, leading to a very narrow incremental term ΔH_{∇}(j). We obtain an observation that is linear in the incremental displacement between two time steps. We take advantage of this observation to compute very accurate enclosures of the incremental displacement as follows. Lumping together terms, we write equation 96 as the linear inclusion

$$Δ ∇ Φ ∈ {H}_{∇} Δ x + [ ϵ ] \qquad ( 99 )$$

The T3D observation Δ∇Φ constrains Δx to a polytope P whose half-space representation is given by

$$( \begin{matrix}- {H}_{∇} Δ x \\ {H}_{∇} Δ x\end{matrix} ) \leq ( \begin{matrix}\overline{ϵ} \\ \underline{ϵ}\end{matrix} ) - ( \begin{matrix}Δ ∇ Φ \\ - Δ ∇ Φ\end{matrix} ) \qquad ( 100 )$$

$$P Δ x \leq k \qquad ( 101 )$$

The corresponding C-zonotope Z_{Δx}(tₖ) is then given by Theorem 1 disclosed in “Constrained zonotopes: a new tool for set-based estimation and fault detection”, by J. K. Scott et al. This is used in the filter propagation by setting F(tₖ₋₁)=I₃, B(tₖ₋₁)=I₃, Z_{Δx}(tₖ), Z_{q}(tₖ₋₁)=0.

### 6.2.2. Velocity-Norm Propagation

In this application example, inter-vehicle ranging observations are not synchronized with GNSS observations and arrive at a higher rate. To perform the necessary propagation before updating with a ranging observation, we use a crude model based on norm-bounded relative velocity. For a propagation horizon tₖ−tₖ₋₁ the norm-bound vₘₐₓ defines a sphere with radius r=vₘₐₓ(tₖ−tₖ₋₁). We outer-approximate this sphere by a symmetric C-zonotope, Z^{s} of user-defined complexity. The propagation is then performed by setting

$$F ( {t}_{k - 1} ) = {I}_{3} , B ( {t}_{k - 1} ) = {I}_{3} , {Z}_{u} ( {t}_{k - 1} ) = 0 , {Z}_{q} ( {t}_{k - 1} ) = {Z}^{S} .$$

### 6.3. Update

### 6.3.3. GNSS Update

GNSS code phase single difference observations are governed by

$$Δρ ( {p}_{A} , {p}_{J} , {p}_{S} ) = ‖ {p}_{A} - {p}_{S} ‖ - ‖ {p}_{B} - {p}_{S} ‖ + {ϵ}_{Δ ρ} + Δ Tc \qquad ( 102 )$$

where ϵ_{Δρ} captures residual errors due to hardware noise and residual atmospheric errors, ΔT is the differential receiver clock error and c is the speed of light.

Using d_{S}=p_{A}−p_{S} and p_{B}=p_{A}+x we write more compactly

$$Δρ ( x , {d}_{S} ) = ‖ {d}_{S} ‖ - ‖ {d}_{S} + x ‖ + {ϵ}_{Δρ} + Δ Tc \qquad ( 103 )$$

The differential receiver clock error is removed by forming double differences with respect to a reference satellite R

$$∇ ρ ( x , {d}_{S} , {d}_{R} 0 = ‖ {d}_{S} ‖ - ‖ {d}_{S} + x ‖ - ‖ {d}_{R} ‖ + ‖ {d}_{R} + x ‖ + {ϵ}_{∇ ρ} \qquad ( 104 )$$

Just like carrier phase double differences, double difference code phase observations are thus a nonlinear function of the relative position of A and B and the vectors between absolute vehicle positions and satellite orbit positions. We follow the same strategy as for carrier phase observations to form a linear inclusion for code phase double differences, leading to

$$∇ ρ ∈ {H}_{∇} {Z}_{x} + Z ( [ {ϵ}_{∇ ρ}^{′} ] ) \qquad ( 105 )$$

allowing for an update of the state enclosure.

### 6.3.2. Ranging Update

The inter-vehicle ranging observations are given by

$$r = ‖ x + {R}^{A} {r}_{A} - {R}^{B} {r}_{B} ‖ + {\hat{w}}_{r , k} \qquad ( 106 )$$

with the positions r_{A}, r_{B} of the UWB ranging antenna centers with respect to the GNSS antenna centers in the respective body frame and the device hardware measurement noise ŵᵣ ∈[ŵᵣ]. Equation 106 is subject to parametric uncertainties due to uncertainty in the attitudes R^{A}, R^{B} of both UAS as well as uncertain antenna positions r_{A}, r_{B}.

In the following we assume that r_{A}, r_{B} are small, i.e. the ranging antennas are close to the GNSS antennas, and that interval bounds of their additive effect on the range observation have been determined and lumped into a combined range error wᵣ:

$$r = ‖ x ‖ + {w}_{r} \qquad ( 107 )$$

To linearize equation 107, we first write range observations as

$$r = {( {x}^{T} x )}^{1 / 2} + {w}_{r} \qquad ( 108 )$$

The first order interval Taylor expansion of equation 108 follows in the same vein as for GNSS carrier phase observations

$$r = ‖ \hat{x} ‖ + \frac{\partial r}{\partial x} ( x - \hat{x} ) + {ϵ}_{r} + {w}_{r}$$

with the Jacobian and Hessian

$$\frac{\partial r}{\partial x} = {( {x}^{T} x )}^{- 1 / 2} {x}^{T} \qquad ( 109 )$$

$$\frac{{\partial }^{2} r}{\partial {x}^{2}} = {( {x}^{T} x )}^{- 1 / 2} {I}_{3} - {x ( {x}^{T} x )}^{- 3 / 2} {x}^{T} \qquad ( 110 )$$

Geometrically, this linearized range observation corresponds to the relative position vector projected on the gradient vector

$$\frac{\partial r}{\partial x} ,$$

while the nonlinear slant range corresponds to a sphere. Although a good approximation at Large distances, the increasing curvature of the sphere introduces larger linearization errors as vehicles get closer to one another, rendering tight enclosures even more crucial.

Applying the generic approach of evaluating the Lagrange remainder term of equation 109 using Interval Arithmetic provides large over-approximation due to the multiple dependencies in x.

The wider the linearization error interval, the less likely it is that the linearized observations can contribute to contracting the guaranteed state set.

In the following we show that by explicitly evaluating the error between the nonlinear observation equation 107 and its linearization, exploiting monotonicity, tighter bounds can be obtained.

The explicit linearization error interval is given by

$$[ {ϵ}_{r} ] = ‖ [ x ] ‖ - ‖ mid ( [ x ] ) ‖ - \frac{\partial r}{\partial x} ( [ x ] - mid ( [ x ] ) )$$

To verify monotonicity of equation 111 with respect to [x], consider the interval-valued gradient

$$\begin{matrix}[ \frac{\partial {ϵ}_{r}}{\partial x} ] = {{( {[ x ]}^{T} [ x ] )}^{- 1 / 2} [ x ]}^{T} - \frac{\partial r}{\partial x} ( 111 ) \\ = \frac{[ {x}^{T} ]}{‖ [ x ] ‖} - \frac{{mid ( [ x ] )}^{T}}{‖ mid ( [ x ] ) ‖} ( 112 )\end{matrix}$$

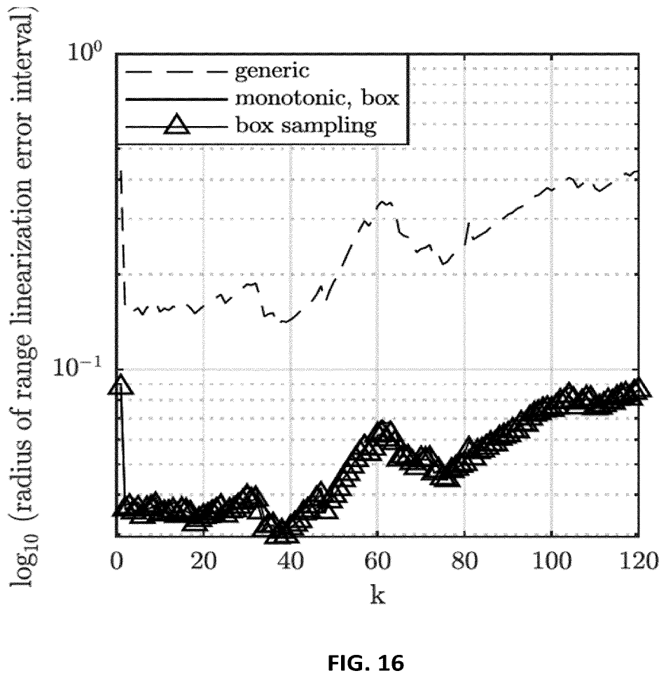

Geometrically, this is the difference between two unit vectors. The expression (111) is thus piecewise monotonic, since the signs of the elements of (112) are constant over subintervals of [x]. Since x∈ [symbol] ³, the number of these subintervals is at most 2³, corresponding to at most 27 unique vertices. By evaluating equation (111) for each of these vertices, an exact enclosure of [ϵᵣ] can be computed. To quantify the benefit of exploiting piecewise monotonicity, we compute the interval with both approaches and compare their respective radii. FIG. 16 displays this measure over the course of a benchmark mission (see section 6.4) along with an inner approximation of the interval obtained by evaluating equation (111) for a large number of samples drawn from the a priori state C-zonotope interval enclosure.

Note that the generic scheme yields interval radii up to four times as large as the scheme exploiting piecewise monotonicity, which in turn closely approximates the interval obtained by sampling.

### 6.4. Simulations

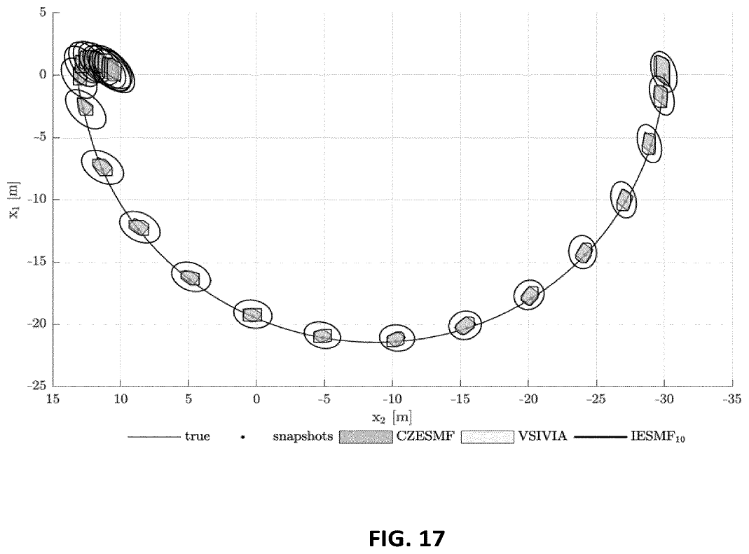

We evaluated the filter on a benchmark UAS maneuver. It consists of two UAS, a leader and a follower. The follower changes its relative position from the right to the left of the x axis on a circular trajectory, see FIG. 17. We track the relative position of both agents at 1 Hz. Simulated GNSS and ranging observations are contaminated with recorded observation errors. For GNSS observations, these are obtained from zero baseline measurements of two low-cost single frequency GPS receivers. Ranging observations errors are obtained form two static UWB ranging beacons placed at a known distance.

### 6.4.1. Set Volumes

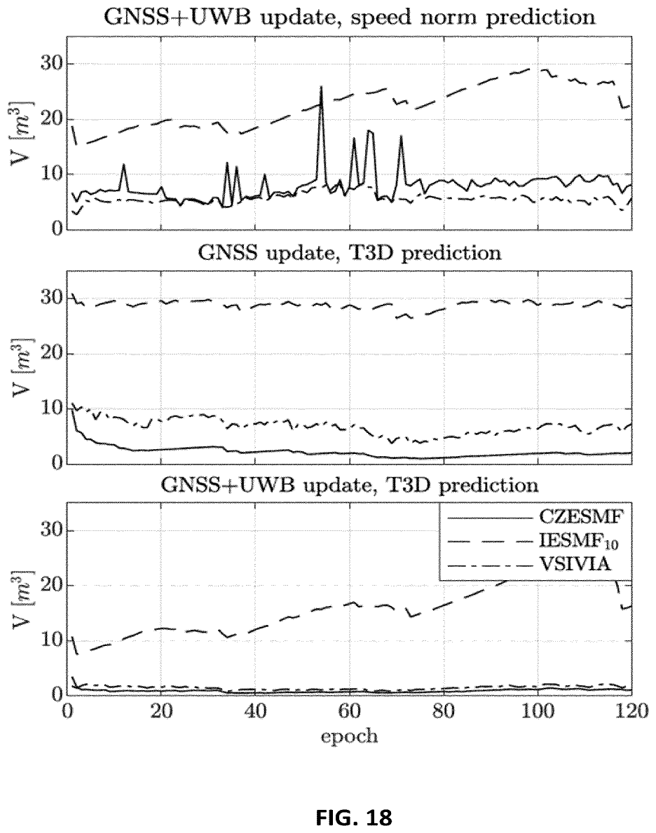

In all three scenarios, the CZESMF filter provides smaller set volumes than both the IESMF (Iterated Extended Set-membership Filter) and VSIVIA (Vector implementation of SIVIA algorithm). We also evaluated the benefit of using T3D observations for propagation, compared to the coarse velocity norm-bound model. As FIG. 18 shows, C-zonotope volumes can be reduced by almost an order of magnitude by using carrier phase information in the propagation step.

### 6.5. Sensitivity to Satellite Constellations

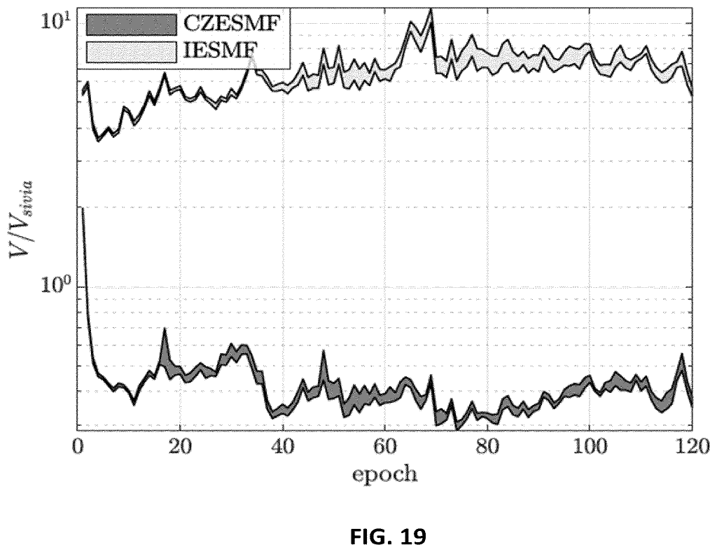

The achievable size and shape of relative position enclosures depend on the baseline-satellite geometry, as captured by the familiar Dilution of Precision (DOP) accuracy measure. It is thus of interest to know whether the relative conservativeness of the presented set-membership filters is robust with respect to variation in satellite constellations. We performed simulations of the benchmark maneuver over a set of randomly selected GPS orbit records. Satellite positions have been computed from a spline fit of the first two minutes of each orbit record. FIG. 19 shows the resulting relative position set volumes of the CZESMF and the IESMF normalized with the subpaving volume obtained by VSIVIA. After an initial transition, the CZESMF shows less conservatism than VSIVIA over all simulations and very little variations with respect to GNSS orbits. The IESMF is significantly more conservative, with similarly low sensitivity to satellite orbits. These simulations provide some confidence that the observed superior tightness of the enclosures computed by the CZESMF can be expected to carry over to an online implementation of the filter.

### 7. Conclusion

The set state estimation method described above for nonlinear systems based on C-zonotopes robustly outperforms (in terms of set volumes) a nonlinear offline set estimator based on VSIVIA as well as a recent fast ellipsoidal set state estimator in a simulation scenario.

The proposed filter can be applied to a wide variety of estimation problems, including Simultaneous Localization And Mapping (SLAM), an exciting perspective in light of the current interest in safe visual localization of road vehicles.

### APPENDIX A: APPROXIMATING A 2-DIMENSIONAL OR 3-DIMENSIONAL BALL WITH A C-ZONOTOPE

To approximate a ball of radius r centered at c, we compute an approximation in H-rep and convert it to a C-zonotope.

Given a vector of angles θ=(θ₁, θ₂, . . . , θₗ) evenly spaced in the interval

$$[ - \frac{π}{2} , \frac{π}{2} ] and ϕ = ( {ϕ}_{1} , {ϕ}_{2} , … , {ϕ}_{l} )$$

evenly spaced on [0, 2π] wherein θ is the zenith angle and φ is the azimuth angle and l is a complexity parameter, we compute for each combination of angles (θᵢ, φⱼ) a corresponding normal vector

$${n}_{i , j} = ( \begin{matrix}sin {θ}_{i} cos {ϕ}_{j} \\ sin {θ}_{i} sin {ϕ}_{j} \\ cos {θ}_{i}\end{matrix} ) \qquad ( A \text{.1} )$$

Each of these normal vectors define a half-space. We can then readily write the corresponding polytope in H-rep

$$[ \begin{matrix}{n}_{1 , 1}^{T} \\ {n}_{1 , 2}^{T} \\ {n}_{2 , 1}^{T} \\ ⋮ \\ {n}_{l , l}^{T}\end{matrix} ] x \leq r ( \begin{matrix}1 \\ 1 \\ 1 \\ ⋮1\end{matrix} ) \qquad ( A \text{.2} )$$

and convert it to G-rep. using the method given in “Constrained zonotopes: A new tool for set-based estimation and fault detection”, by J. K. Scott et al.

In two dimensions, the same approach is performed over a single set of angles θ=(θ₁, θ₂, . . . , θₗ) evenly spaced on [0, 2π].

1. Method comprising:
a) linearizing a nonlinear transition model at an element of a first constrained zonotope enclosing a motion state of at least one mobile target at a first moment, so as to produce a linear transition model,
b) computing transition linearization errors at different elements of the first constrained zonotope, wherein the transition linearization errors comprise a transition linearization error at a given element of the first constrained zonotope being a difference between an output resulting from applying the nonlinear transition model to the given element and an output resulting from applying the linear transition model to the given element,
c) computing a second constrained zonotope that contains all the linearization errors,
d) propagating the first constrained zonotope so as to obtain an a priori constrained zonotope enclosing the motion state at a second moment after the first moment, wherein the a priori constrained zonotope is a linear projection of a hypercube, the hypercube being subject to at least one linear constraint, and wherein propagating the first constrained zonotope comprises:
applying the linear transition model to the first constrained zonotope so as to produce a third constrained zonotope, and
summing the second constrained zonotope and the third constrained zonotope,
e) updating the a priori constrained zonotope so as to obtain an a posteriori constrained zonotope enclosing the motion state at the second moment, wherein updating the a priori constrained zonotope comprises applying an observation model to the a priori constrained zonotope and to observation data of the mobile target acquired by at least one sensor.

2. Method of the claim 1, wherein the element at which the nonlinear transition model is linearized is a center of a smallest interval enclosure containing the first constrained zonotope.

3. Method of claim 1, further comprising linearizing a nonlinear observation model at an element of the first constrained zonotope or the a priori zonotope, so as to produce a linear observation model, wherein the observation model used at step e) is the linear observation model produced.

4. Method of claim 3, wherein the element at which the nonlinear observation model is linearized is a center of a smallest interval enclosure containing the a priori zonotope.

5. Method of claim 3, further comprising:
computing observation linearization errors at different elements of the first constrained zonotope or the a priori zonotope, wherein the observation linearization errors comprise an observation linearization error at a given element of the first constrained zonotope or the a priori zonotope being a difference between an output resulting from applying the nonlinear observation model to the given element and an output resulting from applying the linear observation model to the given element,
computing a fourth constrained zonotope that contains all the observation linearization errors, wherein the a posteriori constrained zonotope depends on the fourth constrained zonotope.

6. Method according to claim 1, wherein the observation data of the mobile target has been acquired at a third moment different from the second moment, and wherein the method further comprises:
inflating the fourth constrained zonotope so as to obtain an inflated constrained zonotope forming a strip in a space and taking into account all possible variations of the motion state between the second moment and the third moment, and taking into account measurement noise induced by the sensor,
computing the a posteriori constrained zonotope as an intersection between the a priori constrained zonotope and the inflated constrained zonotope.

7. Method of claim 1, further comprising:
determining a complexity level of the a posteriori constrained zonotope,
if the complexity level is greater than a threshold, applying a reduction process to the a posteriori constrained zonotope so as to obtain an a posteriori zonotope having a lower complexity than before the reduction and containing the a posteriori zonotope.

8. Method of claim 1, further comprising repeating steps a) to e), wherein said repeating comprises using the a posteriori constrained zonotope as first constrained zonotope and using the second moment as first moment.

9. Method of claim 1, further comprising
computing a maximum time interval between the first moment and a moment at which the observation data has been acquired by the sensor,
if the maximum time interval is greater than a predetermined duration, applying the linear transition model to the predetermined constrained zonotope so as to produce the a priori constrained zonotope, else using the predetermined constrained zonotope as the a priori constrained zonotope.

10. Method of claim 1, wherein the observation data comprises at least one of the following data acquired by a GNSS receiver: a pseudo-range, a carrier phase acquired, a range between the mobile target and another mobile target.

11. Method of claim 1, wherein the motion data includes motion data of the mobile target relative to another mobile target.

12. Method of claim 1, wherein the first constrained zonotope is computed using a Vector Set Inverter Via Interval Analysis algorithm.

13. A non-transitory computer-readable medium comprising code instructions for causing a computer to perform the method as claimed in claim 1.

14. Method of claim 4, further comprising:
computing observation linearization errors at different elements of the first constrained zonotope or the a priori zonotope, wherein the observation linearization errors comprise an observation linearization error at a given element of the first constrained zonotope or the a priori zonotope being a difference between an output resulting from applying the nonlinear observation model to the given element and an output resulting from applying the linear observation model to the given element,
computing a fourth constrained zonotope that contains all the observation linearization errors, wherein the a posteriori constrained zonotope depends on the fourth constrained zonotope.
